(19) United States
(12) Patent Application Publication
(10) Pub. No.: US 2018/0335390 A1
(43) Pub. Date: Nov. 22, 2018

(54) DETECTION OF ORGANIC COMPOUNDS

(71) Applicant: Hing Yiu Leung, Hong Kong (HK)

(72) Inventor: Hing Yiu Leung, Hong Kong (HK)

(21) Appl. No.: 16/048,327

(22) Filed: Jul. 29, 2018

Related U.S. Application Data
(63) Continuation-in-part of application No. PCT/IB2017/050431, filed on Jan. 27, 2017.

(30) Foreign Application Priority Data
Jan. 29, 2016 (HK) 16101090.9

(51) Int. Cl. G01N 21/78; G01N 21/77; G01N 21/64

(52) U.S. Cl. CPC G01N 21/78; G01N 21/77; G01N 2201/062; G01N 2021/7786; G01N 21/6428

(57) ABSTRACT

A method of determining concentration of a target organic compound in a sample, the method comprising dissolving a target sample in an organic solvent to obtain a sample solution, applying a probing device to the sample solution to form a target analyte, wherein the probing device is an SMIP probe comprising a solvatochromic molecularly imprinted polymer, and the SMIP probe comprises a solvatochromic functional group or a solvatochromic functional monomer the colour and/or fluorescence properties of which will change upon coupling or encountering the target organic compound or when the target organic compound is captured by the SMIP probe, and detecting or determining presence and concentration of the target organic compound with reference to a responsive optical signal such as colorimetric, luminescent and/or fluorescent response of the target analyte.

### CROSS-REFERENCE OF RELATED APPLICATION

This is a continuation-in-part application of PCT patent application no. PCT/IB/2017/050431 filed on Jan. 27, 2017 which claims the benefit of Hong Kong patent application no. 16101090.9 filed on Jan. 29, 2016.

### FIELD OF TECHNOLOGY

The present disclosure relates to detection of organic compounds, and more particularly, the detection of phthalates and phthalate-based organic compounds.

### BACKGROUND

Organic compounds are widely present in the environment. Rubber, plastics, fuel, pharmaceutical, cosmetics, detergent, coatings, dyestuff, volatile organic compounds, and agrichemical substances, to name a few, are example organic compounds which are present in the environment and which people come in contact almost on a daily basis. Some organic compounds are harmful, non-friendly, or noteworthy.

Plasticizers or dispersants are organic compound additives that enhance the plasticity or fluidity of a material. While plasticizers are primarily used in plastics, especially polyvinyl chloride (PVC), plasticizers are also blended in other materials including concrete, clays, and related products to improve or modify their properties.

While plasticizers are useful, prolonged exposure to some plasticizers has been known to pose health risks. For example, long-term exposure to DEHP is found to affect the liver and kidney as well as the reproduction and development of experimental animals. DEHP is classified as possibly carcinogenic to humans. Compared with DEHP, DINP has lower toxicity. Chronic large-dose exposure to DBP was found to affect the reproduction and development and cause birth defect in experimental animals.

Currently, plasticizers and other organic compounds are typically detected using gas chromatography mass spectrometers (GC-MS) which are bulky, expensive and requires tedious operation procedures.

Simple and expedient detection schemes and detection apparatus of reasonable accuracy for detection of plasticizers and other organic compounds are therefore desirable.

### SUMMARY

An organic compound detector is disclosed. The detector comprises a solvatochromic molecularly imprinted polymer (“SMIP”) which is affinitive or complementary to a target organic compound, and the molecular imprinted polymer (or more specifically, its solvatochromic functional group such as its solvatochromic functional monomer) is to change colour when the target organic compound is captured by or coupled with the SMIP.

In some embodiment, the molecularly imprinted polymer is for capturing an organic compound comprising one or more than one functional group as shown in Tables 1A-1H.

In some embodiment, the detector is having receptor site that is affinitive or complementary to a target phthalate or a phthalate-based plasticizer. The target phthalate or the phthalate-based plasticizer is any one of the phthalate shown in Table 3.

In some embodiment, the molecular imprinted polymer comprises a solvatochromic functional monomer having the structure:

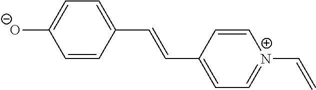 [SMILES: C=C[n+]1ccc(/C=C/c2ccc([O-])cc2)cc1]

Since a molecularly imprinted polymer can be tailor-made for or to bind with a specific organic compound, and more particular to bind with a specific or characteristic functional group of the specific organic compound, the detector is specific for the specific organic compound, in particular organic compound having a particular functional group. Qualitative analysis and quantitative analysis can be achieved without (or with less) interference and unstable test result due to a mix of different organic compounds in a sample can be mitigated. It is a unique solvatochromic property of a solvatochromic MIP that the wavelength distribution and/or intensity of a characteristic wavelength of a composite analyte formed by capturing of a target organic compound by a solvatochromic MIP changes with changing concentration of the composite analyte, and this unique solvatochromic property is utilized herein to facilitate rapid and efficient solvatochromic detection of organic compounds.

A method of detecting presence and/or determining concentration of a target organic compound in a sample is disclosed. The method comprising dissolving a target sample in an organic solvent to obtain a sample solution; applying a probing device to the sample solution to form a target analyte, the probing device comprising a solvatochromic molecularly imprinted polymer or SMIP, and the SMIP comprising a solvatochromic functional group or a solvatochromic functional monomer the colour and/or fluorescence properties of which will change upon coupling or encountering the target organic compound or when the target organic compound is captured by the SMIP; and detecting or determining presence and/or concentration of the target organic compound with reference to colorimetric, luminescent and/or fluorescent response of the target analyte.

A detection apparatus for detection of organic compound is disclosed. The apparatus comprises a sample receptacle for receiving a sample, an optical arrangement for emitting a source optical signal towards the sample and for detecting a responsive optical signal from the sample, and a processor to determine qualitative and/or quantitative information of the organic compound in the sample according to solvatochromic properties of the sample, for example, according to solvatochromic properties and/or with reference to colorimetric, luminescent and/or fluorescent response of the target analyte. The target analyte comprises analyte composites and each analyte composite comprises a probing device and a target organic compound or at least a characteristic functional group thereof. The probing device comprises a solvatochromic molecularly imprinted polymer or SMIP, and the SMIP comprises a solvatochromic functional group or a solvatochromic functional monomer. The colour and/or fluorescence properties of the solvatochromic functional group or the solvatochromic functional monomer is to change upon encountering or coupling with the target organic compound.

The detector is light weight, portable and low-cost while providing rapid, reasonably accurate and cost-effective test results. The detector is particularly useful for a small buying office, retailer and manufacturing factory to help determine whether materials of a finished product do comply with concentration limits or allowance of specific types of organic compounds, for example, limit of phthalate or plasticizers in accordance with the requirements of part three of ASTMF963 of CPSC and part three of EN71 of 2009/48/EC.

A sample extraction apparatus for rapid extraction of samples to facilitate detection of an organic compound or organic compounds is also disclosed. The apparatus comprises a heating chamber and an enclosed sample container. The enclosed sample container has a bottom portion and an enclosed upper portion. The heating chamber is for heating sample on the bottom portion for sample collection at the enclosed upper portion.

A method of organic compound sample extraction for quantitative or concentration determination is disclosed. The method comprising placing a first predetermined weight of an organic compound containing sample inside a sample container and closing the sample container to form an enclosed sample container, the enclosed sample container comprising a bottom portion, a top portion and an upper portion comprising an intermediate wall dependent from the top portion; heating the bottom portion of the sample container to vaporize the organic compound to deposit on the top and/or upper portions of the enclosed sample container when the sample is on the bottom portion of the enclosed sample container; and dissolving the organic compound from the sample container in a second predetermined amount of a polar organic solvent.

In some embodiments, the method of organic compound sample extraction is performed with ethanol as the solvent. In some embodiments, the heating is performed at high temperature under sealed conditions.

The method of sample extraction facilitates operation by personnel with limited or no chemical background since a non-toxic solvent, such as ethanol, may be used.

Therefore, there is provided, in combination, a sample extraction apparatus, a organic compound detection and/or a detection apparatus for detection of a target organic compound in a sample, as disclosed herein.

The use in combination of a novel extraction device, a detection apparatus, and solvatochromic MIP capture reagents disclosed herein facilitates solvatochromic MIP capture reagents disclosed herein facilitates rapid screening tests while achieving a reasonably high sensitivity and accuracy, for example,40-100 ppm with solid or liquid material samples. As an example, sample extraction can be done 4-6 times faster than sample extraction using conventional pre-chemical (extraction) processes, the MIP reagent test can take less than one minute to perform qualitative analysis and less than 3 minutes to perform quantitative analysis under UV optical sensing. Furthermore, as different MIP capture reagents function or operate independently to capture different target organic analytes, interference and instability such as those which would occur in FTIR is mitigated and barriers in the application of anti-body for alcohol, milk or liquid samples can be mitigated.

As solvatochromic MIP capture reagents are low-cost chemosensing agents which are stable and therefore more suitable for long term storage, for example due to its inert polyacrylate material, and which can achieve a higher detection sensitivity, using solvatochromic MIP capture reagents to detect quantitatively and/or quantitatively organic compounds such as phthalates and plasticizers provides a useful alternative to rapid material testing.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure will be described by way of example with reference to the accompanying Figures, in which:

FIG. 1 is a schematic diagram depicting an example detection arrangement with a sample carrier in operational position,

FIG. 2 is a schematic diagram depicting an example detection apparatus,

FIG. 3 is a schematic diagram of an example card-shaped detector,

FIGS. 4A to 4J are curves showing example solvatochromic light emission properties of analytes having different target analyte concentrations,

FIGS. 5A and 5B show graphs of relative light emission intensity and phthalate concentration of several captured phthalate analytes in ethanol,

FIG. 6A is a graph showing correlation between emission light intensity and concentration of SMIP-DnOP composite analytes,

FIG. 6B is an example calibration curve of a detection apparatus,

FIG. 7 is a schematic diagram depicting an example detector,

FIG. 8 is a schematic diagram of an example optical arrangement to cooperate with the detector of FIG. 7 to perform solvatochromic optical measurements,

FIG. 9 is a schematic diagram of a detection apparatus to cooperate with the detector of FIG. 7 and optical arrangement of FIG. 8,

FIG. 10 is a schematic diagram depicting an example detector,

FIG. 11 is a schematic diagram of an example optical arrangement to cooperate with the detector of FIG. 10 to perform solvatochromic optical measurements,

FIG. 12 is a schematic diagram of a detection apparatus to cooperate with the detector of FIG. 10 and optical arrangement of FIG. 11,

FIG. 13 is a schematic diagram of an example detector and an example optical arrangement to cooperate with the detector of FIG. 10 to perform solvatochromic optical measurements,

FIG. 14 is a schematic diagram of a detection apparatus to cooperate with the detector of FIG. 13,

FIG. 15 is a schematic diagram of a sample collection apparatus,

FIG. 15a is a schematic diagram depicting example operation of a sample collection apparatus,

FIG. 16a is a schematic diagram showing part of a sample extraction container, and

FIG. 16b is a schematic diagram showing a sample extraction container.

### DETAILED DESCRIPTION

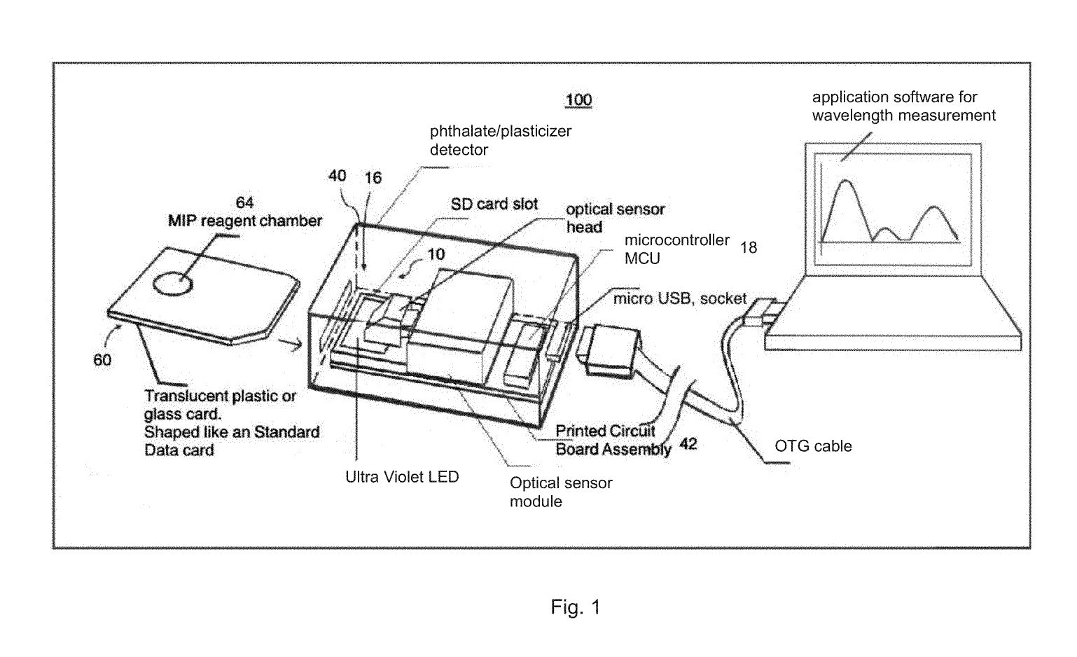

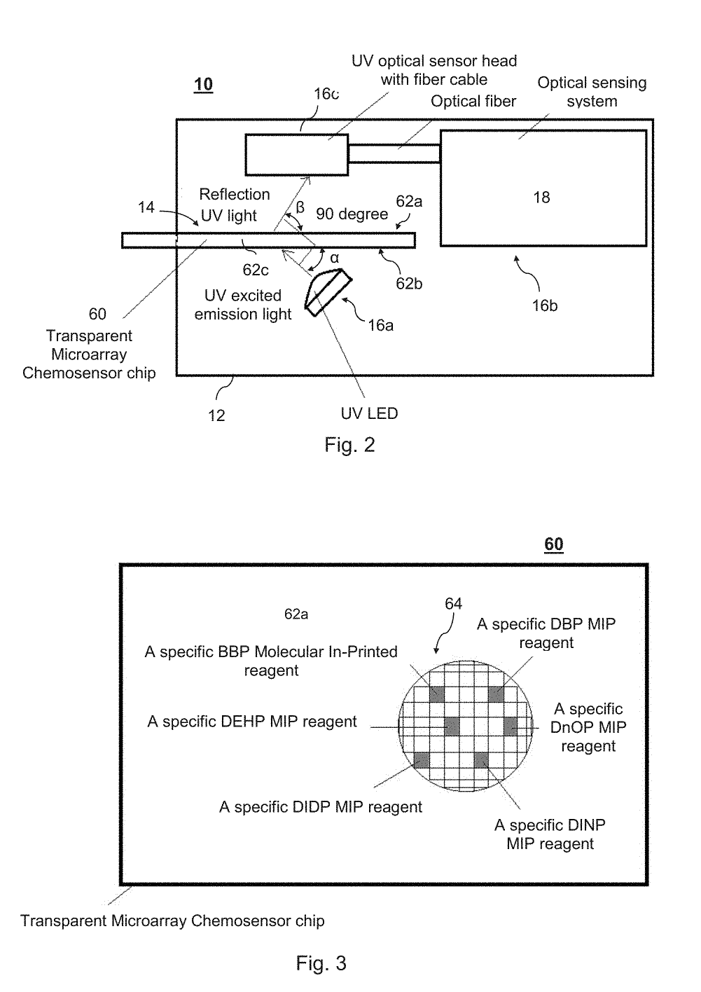

An example detection arrangement 10 comprises an optical compartment 12, a sample receptacle defining a sample compartment 14, an optical arrangement 16 and evaluation circuitry 18, as depicted in FIG. 1. The optical arrangement comprises an optical source 16a and an optical receiver 16b which is connected to a optical sensing head 16c, as depicted in FIG. 2. The optical source 16a is arranged to transmit an optical source signal towards a sample or a plurality of samples carried on a sample carrier and received inside the sample compartment 14 during sample examination operations and the optical receiver 16b is arranged to receive and detect an optical response signal or optical response signals coming from the sample in response to the optical source signal impinging on the sample. To facilitate detection of optical response signals, the optical receiver includes an optical sensor head 16c and signal processing circuitry, for example, a microprocessor based signal processing circuitry, for processing output of the optical sensor head 16c. The signal processing circuitry may include an output for outputting processed signals and data storage devices for storing recorded output spectrum and analyses data.

The sample compartment 14 is arranged to receive and hold a sample carrier, for example, in a closely fitted manner, during sample examination operations. A sample carrier fixture may be formed inside the sample compartment to releasably hold the sample carrier at a predetermined examination position inside the sample compartment. The sample carrier defines a sample receptacle and is arranged so that when a sample carrier is being held at the predetermined detection position during sample examination operations, the optical source signal emitted from the optical source 16a will impinge on the sample or samples carried on the sample carrier and the optical response signal will be forwarded to the optical sensor 16c in response to the optical source signal encountering the sample or samples carried on the sample carrier. The optical sensor 16c will generate an output signal when the optical response signal reaches the optical sensor 16c during sample examination operations, and the signal processing circuitry of the optical receiver 16b will then generate processed output to the evaluation circuitry in response to the detection of the optical response signal for further processing and/or evaluation by the evaluation circuitry.

The evaluation circuitry may comprise a processor and peripheral circuits. The processor may comprise a microprocessor or a microcontroller and the peripheral circuits may comprise signal processing circuits, decision circuits, input/output circuits and data storage devices such as volatile and non-volatile memories for storing instructions and data. During sample analysing operations, the processor of the evaluation circuitry is to evaluate qualitative and/or quantitative characteristics optical properties of the received optical response signal to determine and output qualitative and/or quantitative characteristics of the sample analyte or sample analytes carried on the sample carrier by execution of stored instructions and with reference to stored data and/or decision criteria.

The sample carrier is to be removed from the sample receptacle after sample examination has been performed so that another sample carrier can be received for another sample examination operation to take place. The sample fixture may include a releasable latch for releasably holding the sample carrier in the predetermined examination position.

An example detection apparatus 100 comprises a main housing 40 and the detection arrangement 10 which is mounted inside the main housing 40, as depicted in FIG. 1. The main housing 40 is adapted for portable applications and is shaped and dimensioned for portability and hand-carried mobility. The detection apparatus 100 may be powered by a battery power source inside the main housing or may obtain operational power from an external source, for example, a DC power supply or through a USB connector.

The optical arrangement 16 and the evaluation circuitry 18 are mounted on a main printed circuit board 42 and the main printed circuit board 42 is in turn mounted and enclosed inside the main housing 40. The example optical source comprises an LED which is mounted on an upper surface of the main printed circuit board (“PCB”) and has its light emitting surface facing upwards. The optical sensor includes an optical sensor head and an optical sensor module which supports the optical sensor. Output of the optical sensor module is connected to a microcontroller, for example, the microprocessor inside the optical receiver. The optical compartment and the sample receptacle are both inside the main housing and are defined between the optical source and the optical sensor. The peripheral circuits include a data output port which is mounted on the main printed circuit board. The main housing includes an aperture at its rear end so that an external data connector can be connected to the microcontroller for data delivery. In example embodiments, the peripheral circuits may include wireless data transmission arrangements such as a WiFi device so that measurement data can be transmitted to external devices such as computers, routers or smart-phones installed with appropriate application software.

In example embodiments, solvatochromic MIP capture reagents for capturing a target organic compound or a plurality of target organic compounds are distributed on a sample carrier, for example, in a matrix form. In example applications, the sample carrier is a sensor chip in the form of a transparent sample-carrying card 60 having a first major side 62a, a second major side 62b and a peripheral side 62c interconnecting the first and the second major sides. The sample-carrying card 60 comprises a card-shaped substrate which may be made of transparent hard plastics. As depicted in FIG. 3, a plurality of sample sites is deposited on the first major side 62a or the second major side 62b and each sample site carries a solvatochromic MIP capture reagent. The solvatochromic MIP capture agents may be all of different types and may have duplications to provide testing redundancy and each sample site appears as a sample dot on the sample carrier, as depicted in FIG. 3. In some embodiments, the sensor chip may be for detection of a specific type of organic compound and the sample site or sample sites may be deposited with a single type of solvatochromic MIP capture agents. In some embodiments, the sample sites may carry other types of chemosensors without loss of generality.

So that the card-shaped sample carrier can be held firmly in an analyte examination position for proper sample examination, the sample receptacle may comprise a sample card holding fixture. The sample card holding fixture may include a mounting fixture which is mounted on the main printed circuit board and arranged to firmly hold the sample-carrying card at an examination position when the sample carrier is inserted into the main housing through the sample carrier receiving slot or aperture. When the sample-carrying card is at the examination position, the source LED light will be underneath the sample-carrying card to project a source optical signal towards target locations on the sample-carrying card where samples containing captured analytes in the form of solvatochromic molecularly imprinted polymers (“SMIP”) bound with corresponding matched target analyte as composite analytes are held.

So that the sample-carrying card can move into the examination position from outside the detection apparatus, a sample carrier receiving slot or aperture is formed on a front end of the main housing to correspond to the location of the sample receptacle to provide an entrance to the sample receptacle inside the optical compartment. The optical sensor head is above the sample receptacle for receiving optical response signal coming from the upper surface of the sample-carrying card.

When the sample-carrying card 60 is received inside the main housing 40 and held by the mounting fixture, the sample-carrying card 60 extends along a longitudinal direction X and is held intermediate the optical source 16a and the optical sensor 16c, with its upper surface facing the optical sensor 16c and its lower surface facing the optical source 16a. The optical source 16a is arranged to emit an optical source signal towards the lower major side of the sample-carrying card 60 and at a first angle α to the longitudinal direction. The optical response signal is to emerge from the upper major side of the sample-carrying card and the optical sensor 16c is arranged for collecting a response optical signal which is to travel from the target location at a second angle β to the longitudinal direction. In the example arrangement of FIG. 2, the response optical signal travels at right angle to direction of the optical source signal. The sample-carrying card having a substrate is made of a transparent or translucent plastic material so that the optical source signal after impinging on the underside of the sample-carrying card at the first angle α will emerge at the top side of the sample carrier card at the second angle β and towards the optical sensor.

In some embodiments, the sample carrier is a test tube or other transparent container and the sample receptacle will be correspondingly shaped and adapted for its reception so that due examination can be performed.

In example embodiments, the optical source 16a is arranged to emit an optical excitation signal of a first frequency towards samples carried on a sample carrier and the optical receiver 16b is arranged to detect a target optical response signal that is characteristic of the target analyte when subject to excitation illumination by the target optical excitation signal.

Solvatochromism and molecular imprinting technique are utilized in combination to facilitate qualitative and/or quantitative detection of organic compounds herein. Organic compounds having the example functional groups listed in Tables 1A-1H are suitable for solvatorchromic capturing by corresponding SMIPs. While the example functional groups are those of phthalates or phthalate-based plasticizers, the detection methods, techniques and appliances herein are applicable to organic compounds having other functional groups without loss of generality. A molecularly imprinted polymer (“MIP”) having a receptor site that is suitable for capturing a target organic compound as a target analyte and a solvatochromic functional group that changes color and/or fluorescence properties upon capture of the target organic compounds is devised as a “solvatochromic MIP probe” or “SMIP probe” in short.

A molecularly imprinted polymer (“MIP”) is a polymer that has been processed using the molecular imprinting technique to devise a receptor site that is affinitive or complementary to the target organic compounds. Solvatochromism is the ability of a chemical substance to change color due to a change in media polarity. The design and selection of a MIP probe comprising an effective template and a solvatochromic monomer suitable for capturing a target analyte with selected or preferred solvatochromic properties has been discussed in U.S. Pat. No. 8,338,553; the article entitled “How to find effective functional monomers for effective molecularly imprinted polymers?”, Advanced Drug Delivery Reviews 57 (2005) 1795-1808, and “Optimization, evaluation, and characterization of molecularly imprinted polymers”, Advanced Drug Delivery Reviews 57 (2005) 1779-1794, all of which are incorporated herein by reference.

An SMIP herein comprises a solvatochromic functional monomer which is incorporated as a reporter site within a molecularly imprinted polymer. The solvatochromic functional monomer has a characteristic media polarity and the media polarity changes when a target analyte matched with the solvatochromic functional monomer enters into the reporter site of the molecularly imprinted polymer. As a solvatochromic functional monomer is highly sensitive to the change of the media polarity of receptor micro-environment, the displacing of solvent molecules originally occupying the receptor site by an analyte having a matched solvatochromic functional monomer on entering into the reporter site will bring about a significant change in color and/or luminescent properties of the solvatochromic functional monomer, and the changes can be detected by naked eyes or by spectrum measurement. As intermolecular interaction between a target analyte and the functional monomer is not required in forming a solvatochromic composite, analytes lacking the ability of intermolecular interaction can be detected by SMIP chemosensing approach.

By devising a molecularly imprinted polymer having a solvatochromic receptor site which incorporates a solvatochromic functional group that is affinitive or complementary to a target organic compound, the change in colour and/or change in fluorescence properties when the target organic compound is captured, is noted and utilized to facilitate qualitative and/or quantitative determination of the presence of a target analyte comprising an organic compound.

Therefore, solvatochromic molecularly imprinted polymers (“SMIP”) suitable for capture of organic compound and having a solvatochromic functional monomer that changes colour and/or changes fluorescence properties when the target organic compound is captured are utilized as solvatochromic probes for detection of organic compounds. For example, by fabricating a molecularly imprinted polymer based solvatochromic chemosensor having one or more than one receptor site that is affinitive or complementary to the functional group listed in Table 1A-1H, the solvatochromic functional monomer of the molecularly imprinted polymer based solvatochromic chemosensors will change colour and/or its fluorescence properties when an organic compound having the one or more than one functional group listed in Table 1A-1H is recognized or recognized upon capturing, qualitative and/or quantitative determination of the organic compound can be performed.

In example embodiments where a molecularly imprinted polymer is designed specifically to recognize or capture a target phthalate or a target phthalate-based plasticizer and having at least one solvatochromic functional group, which changes colour and/or fluorescence properties when the target phthalate or the target phthalate-based plasticizer is captured. Such a probe is referred herein as “SMIP plasticizer probes” herein.

Specific binding constants, non-specific binding constants, and density of imprinted binding sites between various example SMIPs and their corresponding target organic compounds as obtained from experimental results and Scatchard analyses are tabulated in Table 2 below:—

TABLE 2

| | Specific | Non-specific | Density of imprinted |
|---|---|---|---|
| | binding constant/ | binding constant/ | binding sites/ |
| Phthalate | M⁻¹ | M⁻¹ | mmol g⁻¹-MIP |
| DMP | 1.10 × 10⁵ | 2.08 × 10³ | 0.11 |
| DEP | 1.20 × 10⁵ | 2.37 × 10³ | 0.21 |
| DBP | 1.10 × 10⁵ | 5.99 × 10³ | 0.22 |
| DNOP | 9.40 × 10⁴ | 6.74 × 10³ | 0.13 |
| DIDP | 1.20 × 10⁵ | 3.24 × 10³ | 0.21 |
| DEHP | 1.14 × 10⁵ | 8.33 × 10³ | 0.20 |
| DNHP | 9.10 × 10⁴ | 0.63 × 10³ | 0.25 |
| DINP | 1.60 × 10⁵ | 0.52 × 10³ | 0.17 |
| BBP | 1.20 × 10⁵ | 5.94 × 10³ | 0.22 |

An example solvatochromic functional monomer which is suitable for forming a solvatochromic chromophore inside a receptor site for example application of plasticizer detection has the structure below:

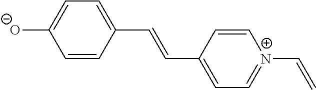 [SMILES: C=C[n+]1ccc(/C=C/c2ccc([O-])cc2)cc1]

In an aspect, the detection arrangement 10 is arranged to examine solvatochromic properties of sample analytes in order to determine presence of a target analyte or target analytes in a sample qualitatively and/or quantitatively.

In some embodiments, the processor is to determine concentration of a target analyte or target analytes in the sample according to detected solvatochromic properties exhibited by the target analytes when subject to the optical excitation signal.

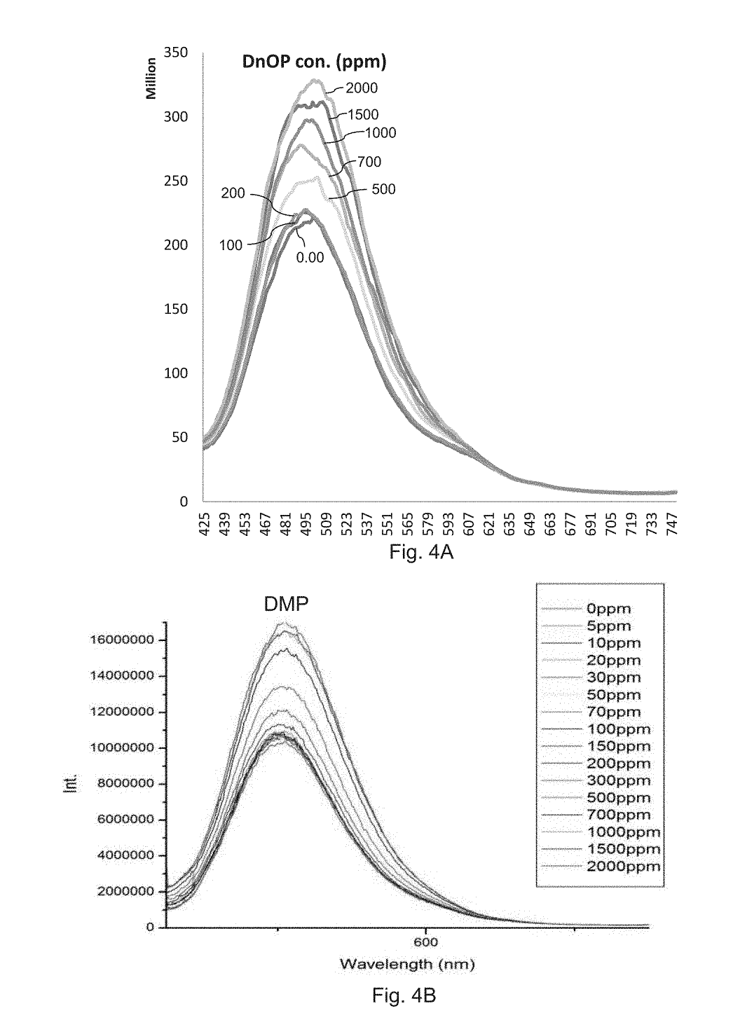

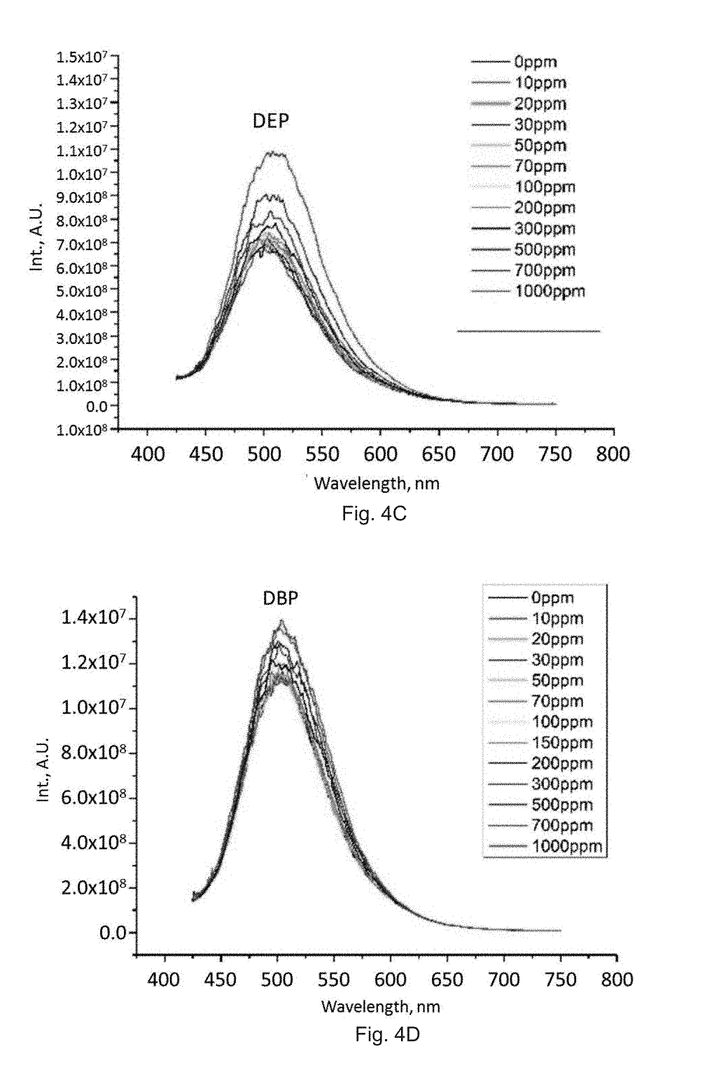

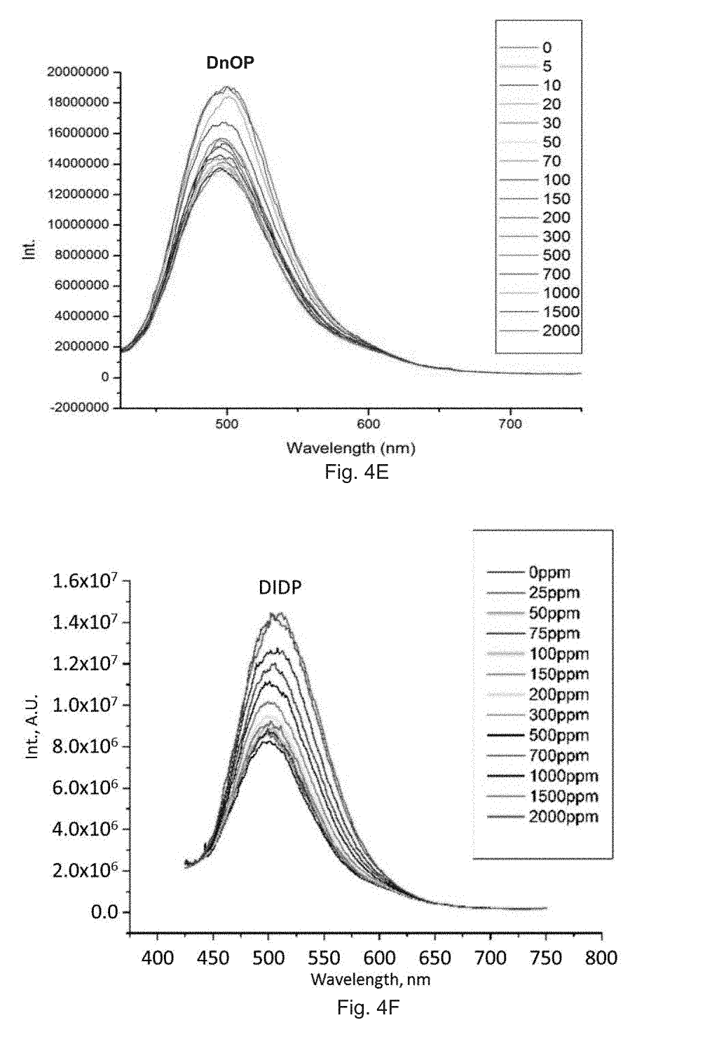

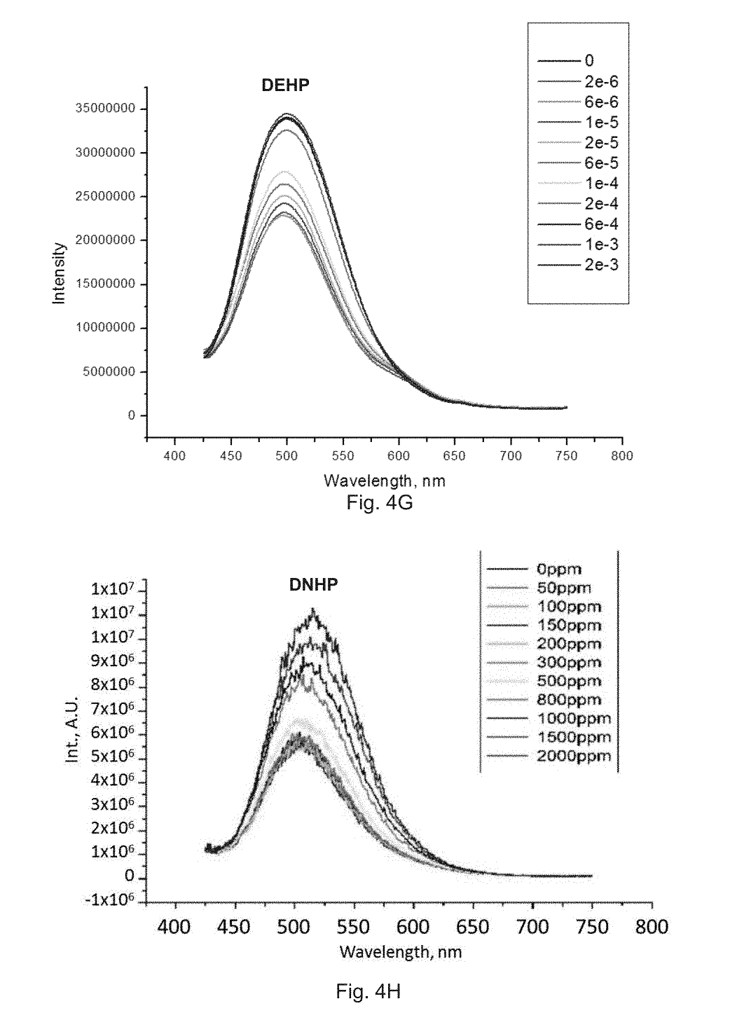

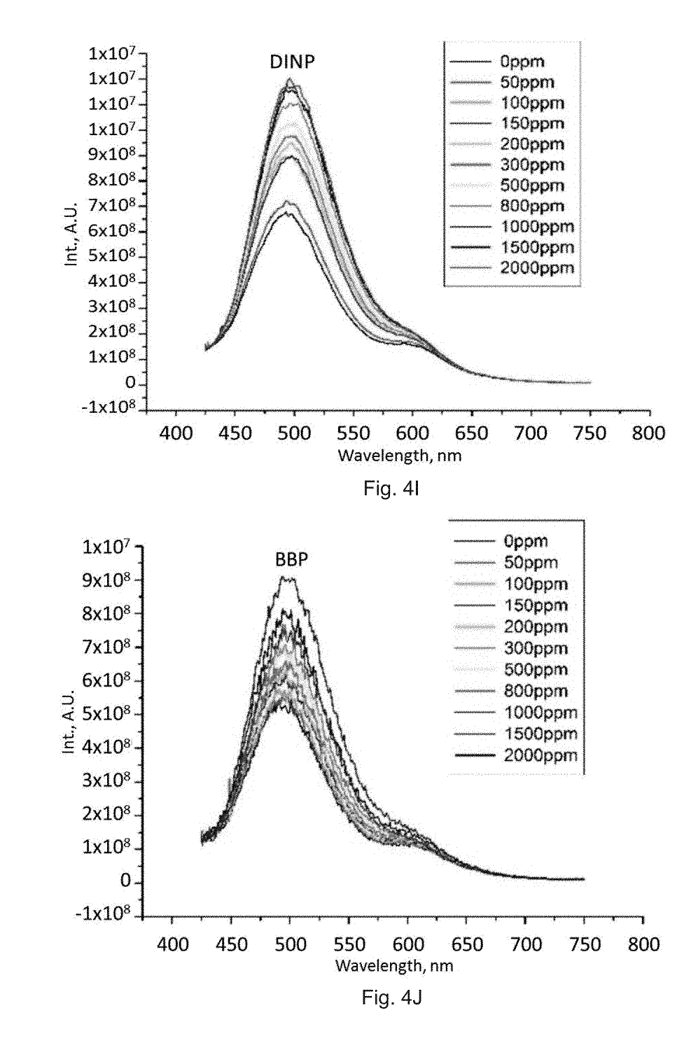

Solvatochromic characteristics of various example composite analytes of phthalates when subject to an excitation light are depicted in FIGS. 4A to 4J. Each type of phthalate composite is a composite analyte comprising an example target phthalate (as a target analyte) captured by an example SMIP probe which is designated for capturing the target phthalate. In the Figures, the vertical axis or Y-axis represents output light intensity and is in intensity units, the horizontal axis or X-axis represents output light wavelengths and is in wavelength units in nm, and the example excitation light is at 400 nm. It will be apparent from FIGS. 4A to 4J that the intensity of the output light, and more particularly, the peak intensity of the output light, changes with changes in the concentration of the target analytes.

Referring to FIG. 4A, the example SMIP probe is devised for capturing DnOP (Di(n-octyl) phthalate, C₆H₄[COO(CH₂)₇CH₃]₂, molecular weight=390.56, CAS no.=117-84-0) in ethanol and the curves show intensity of emitted light of different wavelengths in nanometer (nm) at different concentrations of the composite analyte (DnOP+SMIP). It is noted that the emitted light has wavelengths of between 425 nm and 745 nm and of different intensities when subject to excitation by an excitation optical signal having a wavelength in the ultra-violet (UV) region, for example a wavelength of 400 nm.

Referring to FIG. 4A, the highest curve corresponds to light intensity characteristics of a target analyte having a target analyte concentration of 2,000 ppm, the second highest curve corresponds to light intensity characteristics of a target analyte having a target analyte concentration of 1,500 ppm, the third highest curve corresponds to light intensity characteristics of a target analyte having a target analyte concentration of 1000 ppm, the fourth highest curve corresponds to light intensity characteristics of a target analyte having a target analyte concentration of 700 ppm, the fifth highest curve corresponds to 500 ppm etc., and the lowest curve is at zero target analyte concentration (0.00 ppm).

It is noted from the curves of FIG. 4A that the peak light emission intensity of the example target analyte always occurs at or around 500 nm and the peak intensity of the emitted light generally increases with increasing concentration (or decreases with decreasing concentration) of the target composite analyte. The peak light emission frequency and the light emission spectrum may be considered as a characteristic parameter of the solvatochromic functional monomer of the SMIP and is selectable when designing the SMIP without loss of generality. When the composite analyte in solution is illuminated by UV light, a solution having a higher analyte concentration will exhibit a stronger fluorescence and vice versa, and fluorescence or luminance strength/ intensity can be used to determine concentration. The fluorescence or luminance strength/ intensity can be measured, for example, by a fluorescence spectrometer.

Similar solvatochromic characteristics and trends are observed in other SMIP+phthalate or SMIP+phthalate-based plasticizer composites. A similar trend or behaviour of solvatochromic characteristics that the peak intensity of the emitted light occurs at a relatively constant wavelength and the peak intensity generally increases with increased concentration of the target composite analyte is observed on other phthalates or phthalate-based plasticizers such as DINP, DnOP-T, DMP, DEP, DEHP, BBP, DBP and other phthalates of Table 3.

FIG. 4B shows various intensity curves which are similar to that of FIG. 4A, but in respect of DMP (Dimethyl phthalate), and with 2 mg of SMIP chemosensors loaded in 3 ml of ethanol. The descriptions relating to FIG. 4A are incorporated herein by reference unless the context requires otherwise. The curves correspond to example concentrations of DMP at 0 ppm, 5 ppm, 10 ppm, 20 ppm, 30 ppm, 50 ppm, 70 ppm, 100 ppm, 150 ppm, 200 ppm, 300 ppm, 500 ppm, 700 ppm, 1000 ppm, 1500 ppm, and 2000 ppm, with the highest curve corresponding to light intensity characteristics of a target analyte when the concentration of DMP is 2,000 ppm.

FIG. 4C shows various intensity curves which are similar to that of FIGS. 4A and 4B, but in respect of DEP (Diethyl phthalate), and with 2 mg of SMIP chemosensors loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 1000 ppm, with corresponding concentration shown on a side of the curves, and with the highest curve corresponding to light intensity characteristics of a target analyte when the concentration of DEP is at 1,000 ppm.

FIG. 4D shows various intensity curves which are similar to that of FIGS. 4A and 4B, but in respect of DBP (Dibutyl phthalate), and with 2 mg of SMIP chemosensors loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 1000 ppm, with corresponding concentration shown on a side of the curves, and with the highest curve corresponding to light intensity characteristics of a target analyte when the concentration of DBP is at 1,000 ppm.

FIG. 4E shows various intensity curves which are similar to that of FIGS. 4A and 4B, but in respect of DNOP (Dioctyl phthalate), and with 2 mg of SMIP chemosensors loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 2000 ppm, with corresponding concentration shown on a side of the curves, and with the highest curve corresponding to light intensity characteristics of a target analyte when the concentration of DNOP is at 2,000 ppm.

FIG. 4F shows various intensity curves which are similar to that of FIGS. 4A and 4B, but in respect of DIDP (Diisodecyl phthalate), and with 2 mg of SMTP chemosensors loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 2000 ppm, with corresponding concentration shown on a side of the curves, and with the highest curve corresponding to light intensity characteristics of a target analyte when the concentration of DIDP is at 2,000 ppm.

FIG. 4G shows various intensity curves which are similar to that of FIGS. 4A and 4B, but in respect of DEHP (Di (2-ethylhexyl) phthalate), and with 2 mg of SMIP chemosensors loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 2 mM, with corresponding concentration shown on a side of the curves, and with the highest curve corresponding to light intensity characteristics of a target analyte when the concentration of DEHP is at 2 mM.

FIG. 4H shows various intensity curves which are similar to that of FIGS. 4A and 4B, but in respect of DNHP (Dihexyl phthalate), and with 2 mg of SMTP chemosensors loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 2000 ppm, with corresponding concentration shown on a side of the curves, and with the highest curve corresponding to light intensity characteristics of a target analyte when the concentration of DNHP is at 2,000 ppm.

FIG. 41 shows various intensity curves which are similar to that of FIGS. 4A and 4B, but in respect of DINP (Diisonanyl phthalate), and with 2 mg of SMIP chemosensors loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 2000 ppm, with corresponding concentration shown on a side of the curves, and with the highest curve corresponding to light intensity characteristics of a target analyte when the concentration of DINP is at 2,000 ppm.

FIG. 4J shows various intensity curves which are similar to that of FIGS. 4A and 4B, but in respect of BBP (Benzyl butyl phthalate), and with 2 mg of SMIP chemosensory loaded in 3 ml of ethanol. The descriptions relating to FIGS. 4A and 4B are incorporated mutatis mutandis herein by reference unless the context requires otherwise. The curves correspond to example concentrations of the phthalate between 0 ppm and 2000 ppm, with corresponding concentration shown on a side of the curves, and with the highest curve corresponding to light intensity characteristics of a target analyte when the concentration of BBP is at 2,000 ppm.

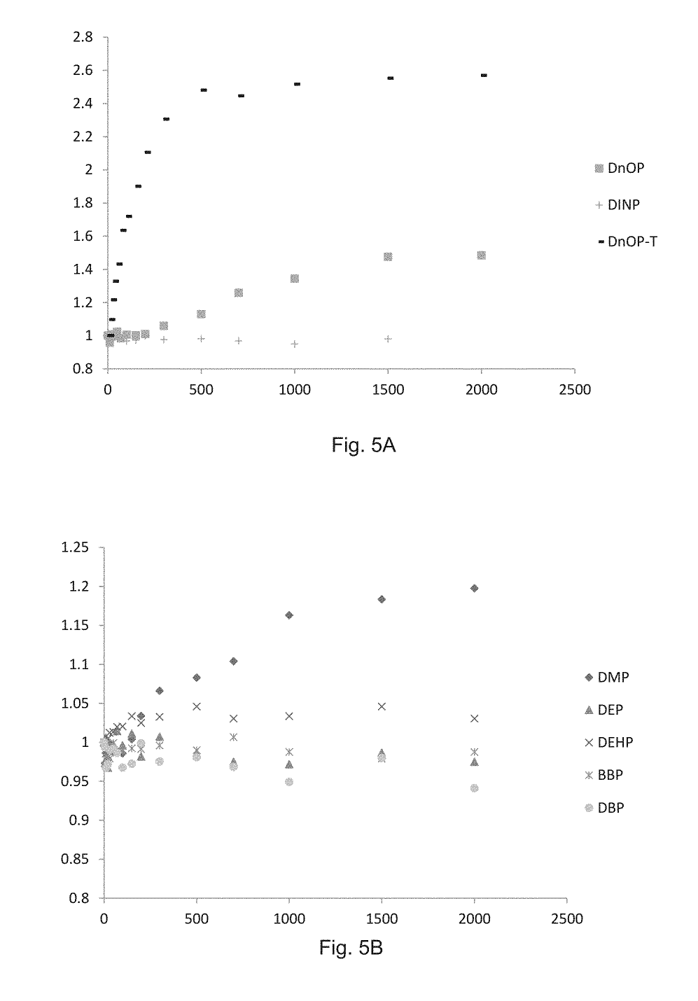

The relationship between light emission intensity and target composite analyte concentrations for different types of SMIP+phthalate or SMIP+phthalate-based plasticizer composites are shown in FIGS. 5A and 5B.

Referring to FIGS. 5A and 5B, the target composite analytes (the DnOP-i-SMIPcomposite) in ethanol are subject to UV light excitation at 400 nm, intensity of fluorescent responsive light at 500 nm is measured and set out on the Y-axis and concentration of the target composite analytes (in ppm) is set out in the X-axis. The intensity values on the Y-axis are relative values with the emission intensity at zero concentration taken as unity reference. As shown in FIGS. 5A and 5B, it is noted that the responsive light emission intensity increases with increased target composite analytes concentration in ethanol. Light intensity is measured, for example, by measurement of photo-current output of the optical sensor. The data of FIGS. 5A and 5B are obtained by loading 2 mg of MIP powder in 3 ml of ethanol and responsive light emission measurements are taken alter 16 hours of loading the target composite analyte in the solvent ethanol.

In addition to the emission of fluorescent light in response to an excitation light, it is observed that the frequency of the fluorescent responsive light also changes, albeit slightly, with changes in target composite analyte concentration. As shown in FIG. 4A, the emission light peaks shift slightly towards increasing or higher wavelength with increasing concentration.

Furthermore, visible fluorescence colour change is also observable by the naked eye when concentration of target composite analyte increases from zero. For example, SMIP-DEHP probe in ethanol changes colour from magenta to yellow and the fluorescent responsive light changes colour from purple to cyan when concentration of the target composite analyte, that is, SMIP-DEHP increases from zero.

While ethanol is used as an example solvent, it should be appreciated that other organic solvents such as DMSO, DMF, methanol, ethanol, iso-propanol, THF, acetone, acetonitrile, dichloromethane, chloroform, ethyl acetate, water, and etc. are also suitable solvents for carrying SMIP-plasticizer probes.

The relationships or correlation between responsive light emission intensity and concentration of the target composite analyte were studied and utilised to devise schemes and apparatus for plasticizer detection.

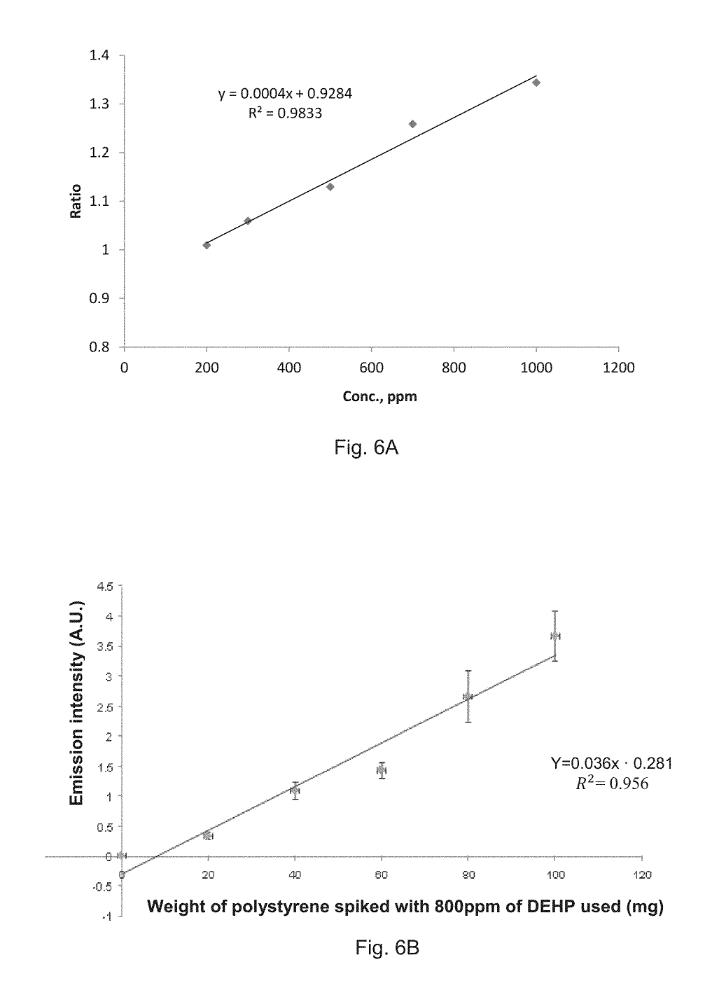

For example, a portion of the solvatochromic properties of the target composite analyte of SMIP·DnOp of FIG. 5A in the concentration range of between 0 and 1200 ppm is shown in FIG. 6A. Referring to FIG. 6A, five data points corresponding to concentrations of 200, 400, 600, 800 and 1000 ppm are plotted. The five data points are distributed substantially about a straight line having the equation Y=0.0004X+0.9284 (equation 1), where Y is intensity ratio (Iₓ/Iₒ), X is concentration in ppm, lₓ is the emission light intensity at concentration X and Iₒ is the emission light intensity at zero concentration. It is noted that the data points have a R² (R square) value of 0.9883, where R is the Pearson correlation coefficient which means that the data points fit very well with the linear equation. Corresponding experimental results are tabulated in Table 4 below.

TABLE 4

| Prepared | | | | | Calculated |
|---|---|---|---|---|---|
| Conc., | Intensity | Intensity | Average | | Conc., |
| ppm | in trial 1 | in trial 2 | Intensity | Ratio | ppm |
| 0 | 22130300 | 22079100 | 22104700 | 1 | |
| 200 | 22370000 | 22343100 | 22356550 | 1.011394 | 207.4838 |
| 400 | 24061000 | 24368200 | 24214600 | 1.09545 | 417.6257 |
| 600 | 26263300 | 26183200 | 26183200 | 1.184508 | 640.2707 |

Example utilization of the correlation between optical properties such as fluorescent light emission intensity and concentration of target composite analytes for determination and/or detection of the presence and/or concentration of phthalates and phthalate-based plasticizers are described in the present disclosure.

Referring to FIG. 3 for example, a plurality of SMIP probes is deposited on the transparent plastic card to form a card-shaped SMIP probe carrier or an SMIP detector. The SMIP probes are distributed at selected probe locations on a matrix of 10 rows and 10 columns. The probe locations are selected such that adjacent probes are spaced by at least one empty cell of the matrix to enhance visibility. Each of the SMIP probe is for a specific target analyte. For example, cell 3,3 is an SNIP probe for capturing BBP (SMIP_BBP probe), cell 3,7 is an SMIP probe for capturing DBP (SMIP_DBP probe), cell 5,4 is an SMIP probe for capturing DEHP (SMIP_DEHP probe), cell 5,8 is an SMIP probe for capturing DnOP (SMIP_DnOP probe), cell 7,2 is an SMIP probe for capturing DIDP ((SMIP_DIDP probe)), and cell 7,6 is an SMIP probe for capturing DINP (SMIP_DINP probe). With such a multiple probe carrier, the presence and concentration of a plurality of different target analytes and their specific types can be expediently determined using the detection apparatus 100.

Each of the six selected probe locations is deposited with a predetermined quantity of the specific SMIP probe (or reagent) to facilitate qualitative and/or qualitative measurements. In the example, each target probe location is square in shape and having an area of 1 mm×1 mm and the totality of the target locations is a probe region 64 delineated in a circular region having a diameter of 10 mm×10 mm.

To calibrate the detection apparatus 100, calibration samples having selected and known target composite analyte concentrations on the sample-carrying card are placed inside the sample receptacle. Optical measurements are performed and calibration readings are obtained and stored. The calibration readings are then utilised by the processor to determine concentration of actual samples on a subsequently inserted target composite analyte carrying sample carrier. For example, where the calibration data are inside a substantially linear correlation region similar to that of FIG. 6A, a linear relationship similar to equation 1 can be used to determine concentration of target composite analyte where the concentration is not at one of the calibration data points. Where the calibration data are not in a linear region, a best fit curve may be used for determination of target composite analyte where the concentration is not at one of the calibration data points. The calibration may be taken by measurement of output currents of the optical sensor at selected calibration data points and accuracy will be enhanced with an increased number of calibration data points. In addition, calibration data points may be selected to be at, around and/or above selected concentration limits to provide qualitative information on whether a threshold limit has been reached, not reached or exceeded. After calibration data of light intensity versus target composite analyte concentration have been obtained and stored, the process upon execution of pre-stored instructions would operate to determine whether concentration of a target composite analyte or a plurality of target composite analytes is at a specific concentration, below a threshold limit, or above a threshold limit without loss of generality. To facilitate quantitative analyses and calibration, each target probe is to fully react with a predetermined amount or volume of target analytes. For example, a target composite analyte of a predetermined weight is dissolved in a solvent of a predetermined weight to form a calibration sample of a predetermined concentration. For example, calibration samples of 0, 1, 2, 3, 4, 5, 6, 7, 8, 9, 10, 20, 40, 60, 80, 100, 200, 400, 600, 800, and 1000 ppm etc., may be used.

For example, calibration samples having predetermined concentration in a solution of a predetermined volume, say 3 ml, may be used for calibration.

In evaluation applications, a sample of a determined weight in the predetermined volume of solution is to react thoroughly with a specific probe and the processor would then operate to determine concentration of a target composite analyte or a plurality of a target composite analytes according to the pre-stored and extrapolated solvatochromic correlation between light intensity and concentration.

During calibration operations, calibration samples carried on a sample-carrying card is received inside the sample receptacle. When the apparatus is set to operate in a calibration mode, the processor will cause the optical source to turn on to emit a source light (say, at 400 nm) towards calibration samples on the sample carrier, and measure intensity of the responsive light (say, of 500 nm) which is emitted by the calibration sample in response to excitation by the source light. By recording intensity of the received responsive lights of the various calibration samples, for example, as represented by output current of the optical sensor, calibration data points are obtained and stored in a storage device such as a non-volatile memory on the apparatus. The processor will then execute stored instructions to identity a best fit line or a best fit curve according to the calibration data points, and then establish a correlation between received responsive light intensity and target composite analyte concentration. The correlation is then stored for use during evaluation applications. To provide specific calibration to specific target locations, a corresponding plurality of optical sensors is disposed to received light from the corresponding plurality of specific target locations without loss of generality.

With the calibration process, relationships between concentrations of a target organic compound and intensity of light at a selected wavelength, selected wavelengths, and/or a range of wavelengths are established for subsequent use in detection and quantitative analyses. During the calibration process, the processor will operate to correlate the light intensity measured, concentrations of the target organic compound in the target analyte solution, and concentrations of the target organic compound in the target material to form and store a calibration data or curves for subsequent detection use. The intensity of light being measured in the examples is intensity of light emitted by the target analyte solution in response to the excitation source light in the UV spectrum, and more specifically, at a selected UV wavelength, e.g., from 270 nm to 420 nm, including UV at 280 nm, 315 nm, 350 nm, 385 nm or 400 nm or any range or ranges between the aforesaid wavelengths. In some embodiments or in combination, the intensity measurement can be transmissivity and/or reflectivity measurements without loss of generality.

During detection mode, a sample-carrying card carrying a plurality of field samples is received inside the sample receptacle. The apparatus is set to operate in a detection mode, and the processor will operate the optical source to emit the source light towards the field samples on the sample carrier, and measure intensity of the responsive light which is emitted by the field samples in response to excitation by the source light. By correlating the measured intensity with the measured intensity versus concentration relationships obtained in the calibration process, the concentration of the target organic compound in a target material can be determined.

To prepare field samples, a predetermined weight of target analyte (say DEHP) is dissolved in a predetermined weight or volume (say 3 ml) of a prescribed solvent (say ethanol). The solution comprising the target analyte is then applied to the SMTP detector so that the target analyte is to react thoroughly (say for 30 minutes) with the SMIP probe or probes on the SMTP detector. The SMTP detector will be placed inside the sample receptacle of the detection apparatus after thorough reaction in order to determine concentration of a target analyte (say DEHP) through use of a target composite analyte (say SMIP·DEHP).

As example calibration curve is shown in FIG. 6B. The emission intensity is plotted against a predetermined concentration of DEHP. An empirical relationship between the emission intensity and the concentration of DEHP is obtained using linear regression analysis. The calibration curve provides a simple and reliable way to calculate the uncertain concentration of DEHP from the emission intensity measured.

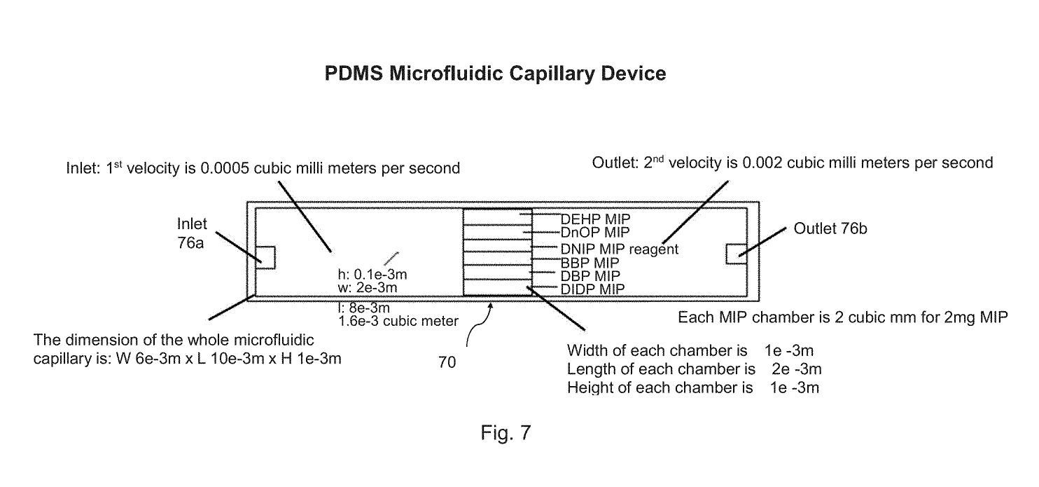

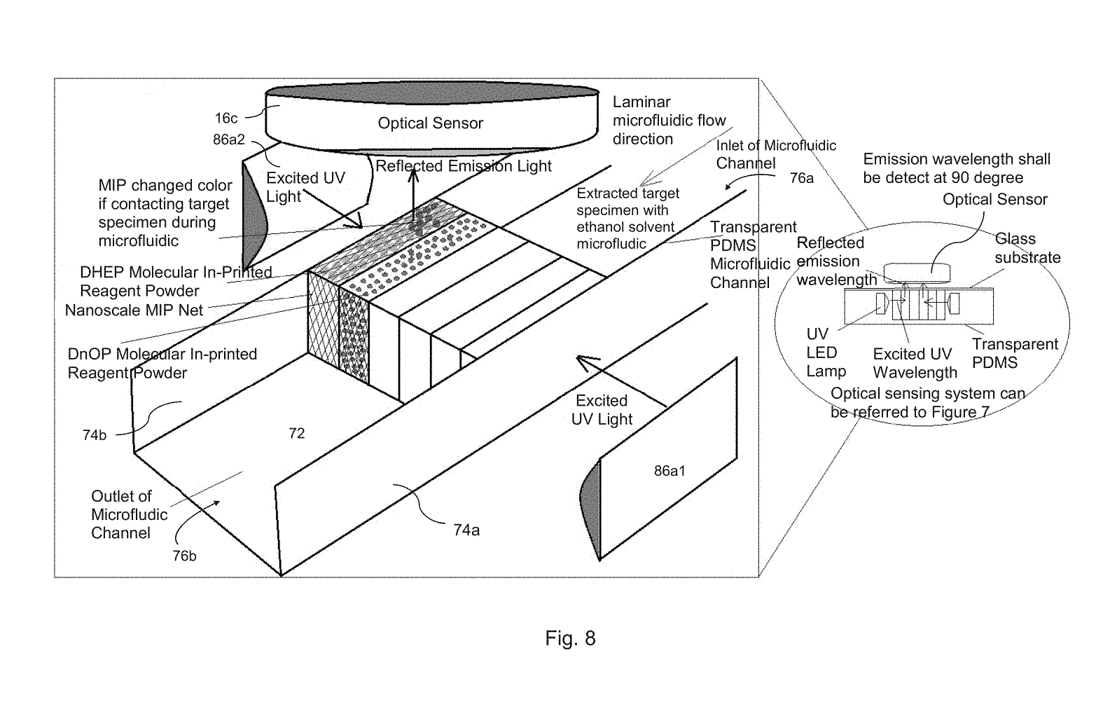

An example detector 70 has a sample carrier comprising one microfluidic capillary device or a plurality of microfluidic capillary devices as depicted in FIG. 7. The sample carrier is of a cartridge type and comprises a transparent and UV-passing carrier housing having a base portion 72 extending in a longitudinal direction, a first side wall 74a extending upwardly from a first lateral side of the base portion and a second side wall 74b extending upwardly from a second lateral side of the base portion. A fluid inlet 76a and a fluid outlet 76b are defined on opposite longitudinal ends of the carrier housing. A plurality of microfluidic capillary devices each carrying a specific SMTP probe is disposed on the carrier housing intermediate the fluid inlet 76a and the fluid outlet 76b.

In the example of FIG. 7, a total of 6 microfluidic capillary devices each carrying a specific SMIP probe is disposed laterally across the carrier housing so that the capillary members of the microfluidic capillary devices are substantially parallel to the longitudinal direction of the carrier housing to facilitate flow of liquid analyte across the microfluidic capillary devices in a direction substantially parallel to the longitudinal direction of the carrier housing. The microfluidic capillary devices are arranged such that an SMIP_DEHP probe is in abutment with the second side wall, with an SMIP_DnOP probe next to and in abutment with the SMIP_DEHP probe, further with an SMIP_DNIP probe next to and in abutment with the SMIP_DnOP probe, further with an SMIP_BBP probe next to and in abutment with the SMIP_DNIP probe, further with an SMIP_DBP probe next to and in abutment with the SMIP_BBP probe, and finally with an SMIP_DIDP probe intermediate and in abutment with the first sidewall 74a and the SMIP_DBP probe. When there is less than the prescribed number of probes, a probe of a larger width or a probe of the same width plus fillers to fill up the lateral space may be used without loss of generality. The microfluidic capillary devices comprise nano-scale SMIP nest, which is made from polydimethylsiloxane (PDMS).

In this example, each of the SMIP probe has a width of 1 mm, a height of 1 mm and a length of 2 mm, defining a chamber volume of 2 mm³ for each probe. The entire sample carrier has a width of 6 mm, length of 10 mm and a height of 1 mm.

In example use, liquid analyte is to enter the microfluidic capillary devices of the detector at the fluid inlet 76a and at 0.0005 mm³ per second and to leave the microfluidic capillary devices at 0.002 mm³ per second.

With the example detector 70, the optical arrangement will be arranged as depicted in FIG. 8. As depicted in FIG. 8, excitation light sources 86a1, 86a2 are disposed on two lateral sides of the carrier housing so that excitation light will be projected in a transversal direction orthogonal to the longitudinal direction and towards the microfluidic capillary devices. The optical sensor 16C is disposed above the microfluidic capillary devices for collection of response light which is orthogonal to the direction of illumination of the source lights 86a1, 86a2.

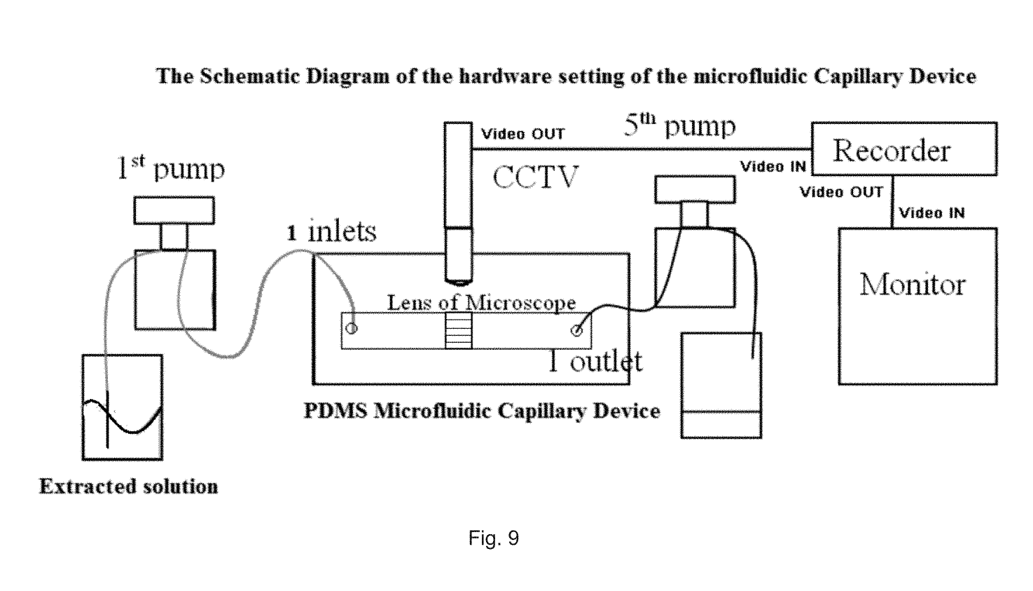

The detection apparatus to cooperate with detector 70 would include a liquid delivery arrangement, as depicted in FIG. 9. The liquid delivery arrangement comprises a first pump which is to deliver liquid analytes to the inlet of the detector and a second pump which is to remove residual liquid from the outlet. Apart from the aforesaid specific modified arrangements, operation and other description above are applicable and the relevant description is incorporated herein. During operations, electromagnetic field is applied to attract superparamagnetic iron oxide (SPIO) nanoparticles materials which are attached to the target composite analytes and the resulting fluorescence intensity at a wavelength of 480 nm to 510 nm is measured to determine concentration.

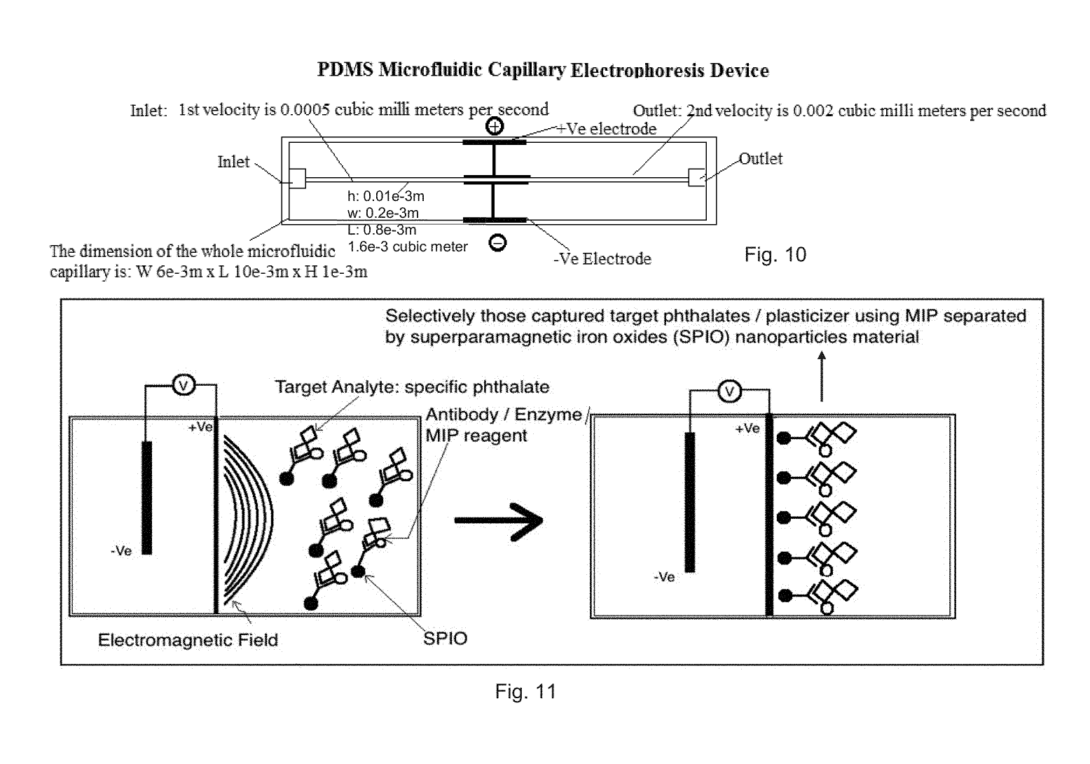

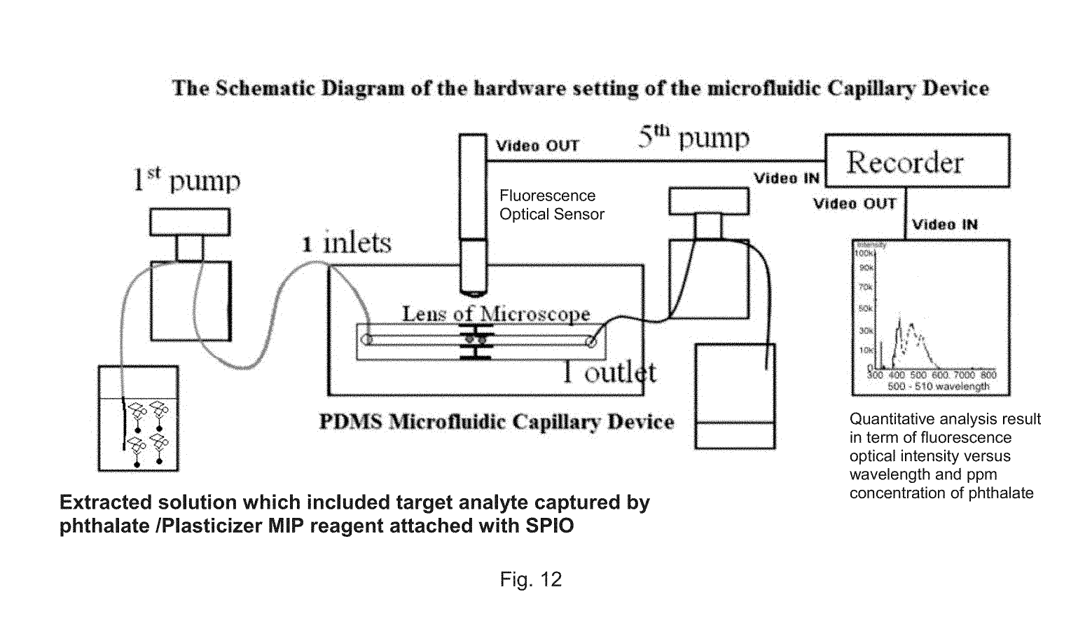

An example detector 80 comprises a PDMS microfluidic capillary electrophoresis device, as depicted in FIG. 10. Operation and properties of this detector 80 are depicted in FIG. 11, and the detection apparatus to cooperate with detector 80 would include a liquid delivery arrangement, as depicted in FIG. 12. Apart from the aforesaid specific modified arrangements, operation and other description above are applicable and the relevant description is incorporated herein.

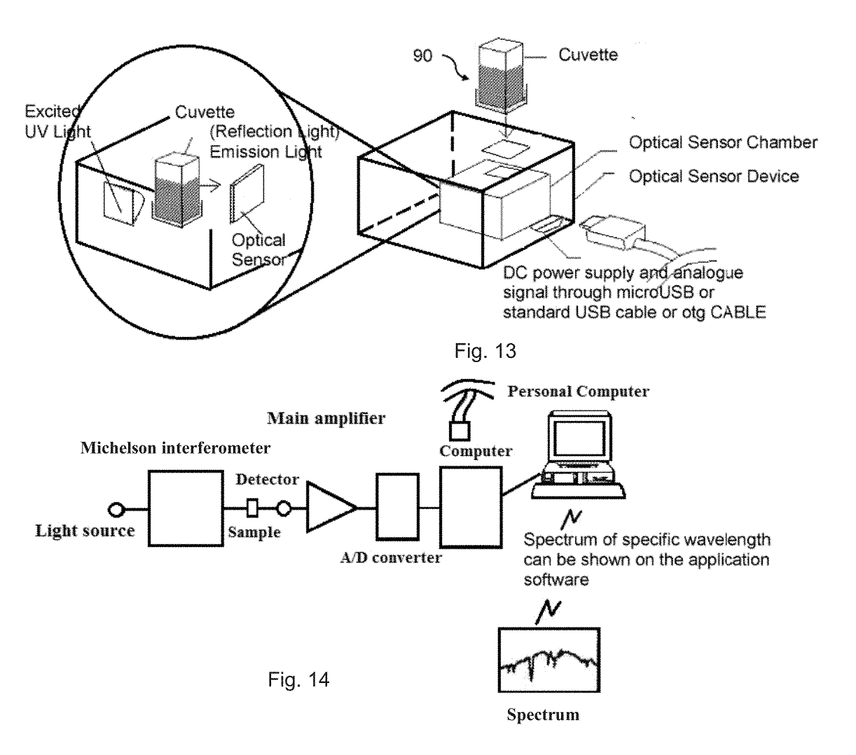

An example detector 90 comprises a transparent tube for receiving liquid analytes, as depicted in FIG. 13. The corresponding optical arrangement and detection apparatus are depicted in FIGS. 13 and 14. Apart from the aforesaid specific modified arrangements, operation and other description above are applicable and the relevant description is incorporated herein.

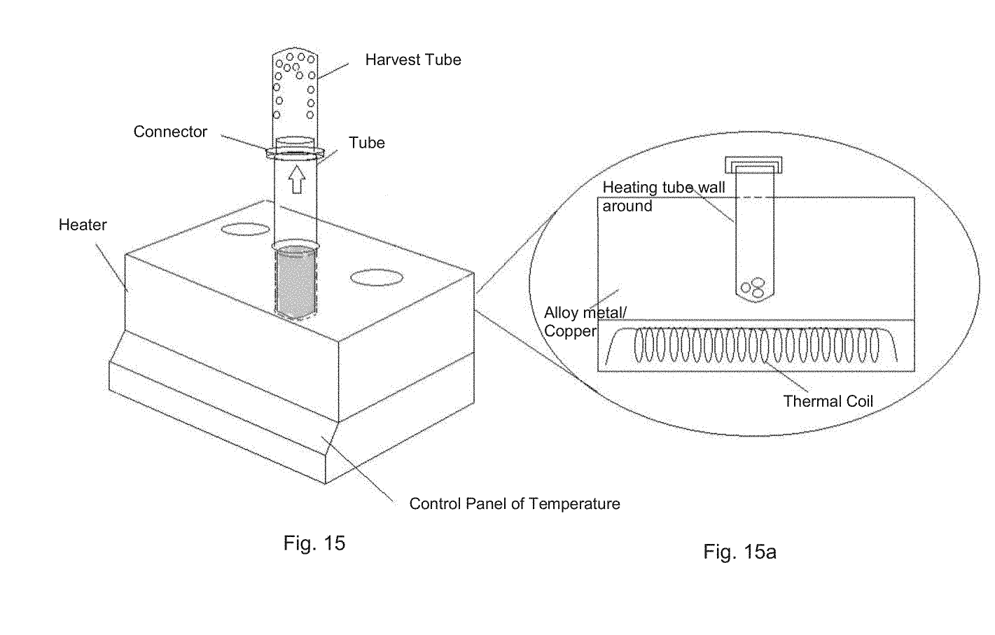

An example field sample extraction apparatus comprising a heating station and a sample collection device is depicted in FIGS. 15 and 15a. The heating station comprises a thermal block and heating elements for heating the thermal block. The thermal block is made of metal and one or a plurality of sample receptacles is formed inside the metal block. During operations, a sample collector containing a sample, for example, a field collected sample is received and seated inside the sample receptacles and the heating elements will heat up the collected sample to a prescribed temperature for a prescribed time set by an operator. The field collected sample may be heated at high temperature under sealed conditions for more expedited and efficient extraction. For example, the collected sample may be heated at, say between 180° C. and 200° C., for say 15-30 mins. In some embodiments, the heating elements may be processor controlled for better operational control and accuracy.

In an example sample extraction operation, a random sample of a known or predetermined weight (say 100 mg) is taken and placed inside a sample collection container (say a glass tube) containing a predetermined weight (say 5 mg) of solvent (say ethanol) and subject to heating for target analyte extraction. The extracted analyte solution can then be used for analyses.

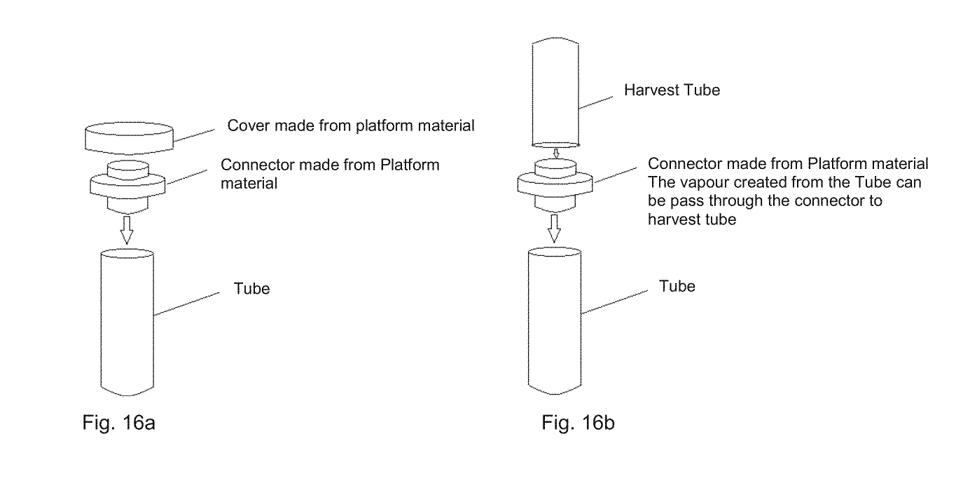

In an example sample extraction operation, a random sample of a known or predetermined weight (say 100 mg) is taken and placed inside a sample collector. The sample collector comprises a lower container (which in this example is a glass tube such as a cuvette tube having a tightly fitted fluid connector at it upper end, as depicted in FIG. 16a. The sample collector is sealed by a sealing cap to form a “pressure-assisted solvent extraction tube”, and the sample containing sample collector is then transferred to the sample extraction apparatus for heated analyte extraction while sealed so that pressure inside the container will increase due to heating. When a plasticizer containing sample is heated under sealed and pressurized conditions, that is, using “pressure-assisted solvent extraction method”, the rate of analyte extraction will be increased. When vaporization of analyte begins to occur, the sealing cap is removed and an upper container (which in this example is a glass tube such as a cuvette tube) having its open end facing the lower container is attached to the upper end of the fluid connector and to the lower container, as depicted in FIG. 16b. With continued heating, target analytes will be fully vaporized and move upwards through a passageway defined in the connector and deposited at an upper closed end or a peripheral wall adjacent the upper closed end of the upper container. The connector is tightly fitted to both the lower and lower containers and a passageway is formed in the connector so that the lower and upper containers are fluid communicable only through an aperture on the connector defining the passage way.

After a prescribed time, which would be a time (say 1 minute) such that all target plasticizer analytes are expected to be fully vaporised and deposited into the upper container, the upper container will be detached from the lower container and the connector and the upper container is filled with a predetermined amount of solvent, say 3 ml of ethanol. The extracted sample is then ready for qualitative and/or quantitative analyses as described herein.

In applications where the sample does not fully move into the upper container, the upper container and/or the lower container will be re-weighted after completion of process to determine the actual amount of target materials that have moved into the upper container to prepare for quantitative analyses.

With the present sample extraction arrangement, samples can be extracted expeditiously and substantially hassle free.

In another example, the extraction method to prepare for qualitative and quantitative analysis is as follows:
mixing 5 ml ethanol with 100 mg sample in lower container or vessel;
inserting the lower container into a thermally controlled cavity defined in a thermal block of the sample extraction apparatus,
fitting a connector to the upper free end of the lower container and then fitting the free end of the upper container to the connector,
turning on the sample extraction apparatus to heat the sample inside the lower container to 140° C. for 30 minutes,
removing the upper container after 30 minutes of heating and turning the upper container upside down so that its free end is facing upwards, and
fill the upper container with 3 ml of ethanol.

Where the target analyte is to be evaluated while in liquid form, a predetermined weight (say 20 mg) of SMIP probe is to be applied to the solution comprising ethanol and the target analyte. The resultant mixture is then subject to qualitative and/or quantitative analysed according to the disclosure.

Where the target analyte is to be evaluated using a solid state detector such as the detectors 60 and 70 herein, a predetermined weight of the solution comprising ethanol and the target analyte will be applied to the solid state detector.

Alternatively, the target samples are extracted by high energy laser direct heating, or by microwave heating (say, 15 mins).

While the present disclosure has been described with reference to example and example embodiments, it should be appreciated that the example and example embodiments are to assist understanding and not meant or intended to be restrictive. For example, while plasticizers such as DINP, DnOP-T, DMP, DEP, DEHP, BBP, DBP are referred to herein, the present disclosure would apply to other phthalates or phthalate-based plasticizers as set out in Table 3 and in general without loss of generality.

TABLE 3
phthalate and phthalate-based plasticizers

| | | | Molecular | |
|---|---|---|---|---|
| Phthalate Name | Abbreviation | Structural formula | weight (g/mol) | CAS No. |
| Dimethyl phthalate | DMP | C₆H₄(COOCH₃)₂ | 194.18 | 131-11-3 |
| Diethyl phthalate | DEP | C₆H₄(COOC₂H₅)₂ | 222.24 | 84-66-2 |
| Diallyl phthalate | DAP | C₆H₄(COOCH₂CH═CH₂)₂ | 246.26 | 131-17-9 |
| Di-n-propyl phthalate | DPP | C₆H₄[COO(CH₂)₂CH₃]₂ | 250.29 | 131-16-8 |
| Di-n-butyl phthalate | DBP | C₆H₄[COO(CH₂)₃CH₃]₂ | 278.34 | 84-74-2 |
| Diisobutyl phthalate | DIBP | C₆H₄[COOCH₂CH(CH₃)₂]₂ | 278.34 | 84-69-5 |
| Butyl cyclohexyl | BCP | CH₃(CH₂)₃OOCC₆H₄COOC₆H₁₁ | 304.38 | 84-64-0 |
| phthalate | | | | |
| Di-n-pentyl phthalate | DNPP | C₆H₄[COO(CH₂)₄CH₃]₂ | 306.4 | 131-18-0 |
| Dicyclohexyl phthalate | DCP | C₆H₄[COOC₆H₁₁]₂ | 330.42 | 84-61-7 |
| Butyl benzyl phthalate | BBP | CH₃(CH₂)₃OOCC₆H₄COOCH₂C₆H₅ | 312.36 | 85-68-7 |
| Di-n-hexyl phthalate | DNHP | C₆H₄[COO(CH₂)₅CH₃]₂ | 334.45 | 84-75-3 |
| Diisohexyl phthalate | DIHxP | C₆H₄[COO(CH₂)₃CH(CH₃)₂]₂ | 334.45 | 146-50-9 |
| Diisoheptyl phthalate | DIHpP | C₆H₄[COO(CH₂)₄CH(CH₃)₂]₂ | 362.5 | 41451-28-9 |
| Butyl decyl phthalate | BDP | CH₃(CH₂)₃OOCC₆H₄COO(CH₂)₉CH₃ | 362.5 | 89-19-0 |
| Di(2-ethylhexyl) | DEHP, DOP | C₆H₄[COOCH₂CH(C₂H₅)(CH₂)₃CH₃]₂ | 390.56 | 117-81-7 |
| phthalate | | | | |
| Di(n-octyl) phthalate | DNOP | C₆H₄[COO(CH₂)₇CH₃]₂ | 390.56 | 117-84-0 |
| Diisooctyl phthalate | DIOP | C₆H₄[COO(CH₂)₅CH(CH₃)₂]₂ | 390.56 | 27554-26-3 |
| n-Octyl n-decyl | ODP | CH₃(CH₂)₇OOCC₆H₄COO(CH₂)₉CH₃ | 418.61 | 119-07-3 |
| phthalate | | | | |
| Diisononyl phthalate | DINP | C₆H₄[COO(CH₂)₆CH(CH₃)₂]₂ | 418.61 | 28553-12-0 |
| Di(2-propylheptyl) | DPHP | C₆H₄[COOCH₂CH(CH₂CH₂CH₃)(CH₂)₄CH₃]₂ | 446.66 | 53306-54-0 |
| phthalate | | | | |
| Diisodecyl phthalate | DIDP | C₆H₄[COO(CH₂)₇CH(CH₃)₂]₂ | 446.66 | 26761-40-0 |
| Diundecyl phthalate | DUP | C₆H₄[COO(CH₂)₁₀CH₃]₂ | 474.72 | 3648-20-2 |
| Diisoundecyl phthalate | DIUP | C₆H₄[COO(CH₂)₈CH(CH₃)₂]₂ | 474.72 | 85507-79-5 |
| Ditridecyl phthalate | DTDP | C₆H₄[COO(CH₂)₁₂CH₃]₂ | 530.82 | 119-06-2 |
| Diisotridecyl phthalate | DIUP | C₆H₄[COO(CH₂)₁₀CH(CH₃)₂]₂ | 530.82 | 68515-47-9 |

Further examples of organic compounds that can be detected according to the present disclosure, may include, for example, organic functional groups such as phthalate esters, AZO, phenol, DOTE (PVC stabilizer), amide, nitrobenzene cosmetic fragrance, phosphate etc. as shown herein and below, and other organic compounds in general without loss of generality.

TABLE 1A
Functional groups of organic compounds

| Organic | | | | | |
|---|---|---|---|---|---|
| Com- | | Chemical Structure of | | | |
| pound | Description | Functional Group | Example | EU | CAS |
| Phthalate Ester | Esters (R—CO—O—R′) are named as alkyl derivatives of carboxylic acids. The alkyl (R′) group is named first. The R—CO—O part is then named as a separate word based on the carboxylic acid name, with the ending changed from -oic acid to -oate. For example, CH₃CH₂CH₂CH₂COOCH₃ is methyl pentanoate, and (CH₃)₂CHCH₂CH₂COOCH₂CH₃ is ethyl 4- methylpentanoate. For esters such asethyl acetate (CH₃COOCH₂CH₃), ethyl formate (HCOOCH₂CH₃) or dimethyl phthalate that are based on common acids, IUPAC recommends use of these established names, called retained names. The -oate changes to -ate. Some simple examples, named both ways, are shown in the figure above. | 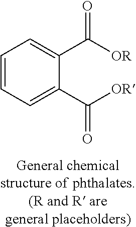 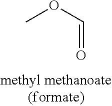 | See another table of 25 phthalates shown on Table 3 | | |
| | | 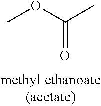 | | | |
| | | 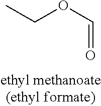 | | | |
| Azo | Azo compounds are compounds bearing the functional group R—N═N—R′, in which R and R′ can be either aryl or alkyl. IUPAC defines azo compounds as: “Derivatives of diazene (diimide), HN═NH, wherein both hydrogens are substituted by hydrocarbyl groups, e.g. PhN═NPh azobenzene or diphenyldiazene.” [1] The more | 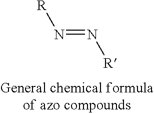 | Disodium 4-amino-3-[[4′-[(2,4- diaminophenyl)azo][1,1′- biphenyl]-4-yl]azo]-5- hydroxy-6- (phenylazo)naphthalene-2,7- disulphonate (C.I. Direct Black 38 Dye) | 217-710-3 | 1937-37-7 |
| | stable derivatives contain two aryl groups. The | | | | |
| | N═N group is called an azo group. The name azo | | | | |
| | comes from azote, the French name for nitrogen | | | | |
| | that is derived from the Greek a (not) + zoe (to | | | | |
| | live) | | | | |

TABLE 1C
Functional groups of organic compounds

| Organic | | | | | |
|---|---|---|---|---|---|
| Com- | | | | | |
| pound | Description | Chemical Structure of Functional Group | Example | EU | CAS |
| Phos- phate | A phosphate (P043-) is an inorganic chemical and a salt of phosphoric acid. In organic chemistry, a phosphate, or organophosphate, is an ester of phosphoric acid. Of the various | 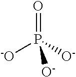 | Tris(2- chloroethyl) phosphate | 204- 118-5 | 115- 96-8 |
| | phosphoric acids and phosphates, | | | | |
| | organic phosphates are important in | | | | |
| | biochemistry and biogeochemistry | | | | |
| | (ecology), and inorganic phosphates | | | | |
| | are mined to obtain phosphorus for | | | | |
| | use in agriculture and industry. At | | | | |
| | elevated temperatures in the solid | | | | |
| | state, phosphates can condense to | | | | |
| | form pyrophosphates. | | | | |
| Thione | Thioketones (also known as thiones or thiocarbonyls) are organosulfur compounds related to conventional ketones. Instead of the formula R₂C═O, thioketones have the formula R₂C═S, which is reflected by the prefix “thio-” in the name of the functional group. Unhindered alkylthioketones typically tend to form polymers or rings. 2-ethylhexyl 10-ethyl-4,4-dioctyl-7- oxo-8-oxa-3,5-dithia-4- stannatetradecanoate and 2- ethylhexyl 10-ethyl-4-[[2-[(2- ethylhexyl)oxy]-2-oxoethyl]thio]-4- octyl-7-oxo-8-oxa-3,5-dithia-4- stannatetradecanoate (reaction mass of DOTE and MOTE) | 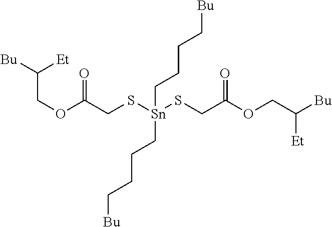 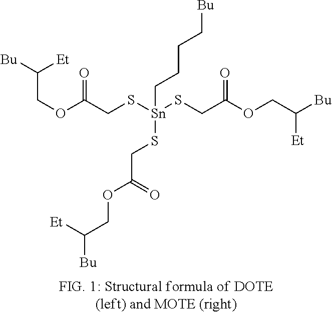 | Imidazolidine- 2-thione (2-imidazoline- 2-thiol) (DOTE) | 202- 506-9 | 96- 45-7 |
| | | 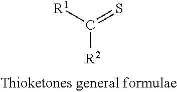 | | | |

TABLE 1E
Functional groups of organic compounds

| Organic | | Chemical Structure of | | | |
|---|---|---|---|---|---|
| Compound | Description | Functional Group | Example | EU | CAS |
| 1,2,3- trichloro- propane | 1,2,3-Trichloropropane (TCP) is a chemical compound that is commonly used as an industrial solvent. Exposure by inhalation, skin contact, or ingestion can be harmful to health. 1,2,3-Trichloropropane can be produced via the chlorination of propylene. Other reported methods for producing 1,2,3- | 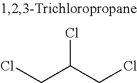 | 1,2,3- trichloropropane | 202- 486-1 | 96-18-4 |
| | trichloropropane include the addition of chlorine to allyl | | | | |
| | chloride, reaction of thionyl chloride with glycerol, and the | | | | |
| | reaction of phosphorus pentachloride with either 1,3- or 2,3- | | | | |
| | dichloropropanol. TCP also may be produced as a byproduct of | | | | |
| | processes primarily used to produce chemicals such as | | | | |
| | dichloropropene (a soil fumigant), propylene chlorohydrin, | | | | |
| | propylene oxide, dichlorohydrin, and glycerol. | | | | |
| Trichloro- ethylene | Trichloroethylene (C₂HCl₃) is a halocarbon commonly used as an industrial solvent. It is a clear non-flammable liquid with a sweet smell. It should not be confused with the similar 1,1,1- trichloroethane, which is commonly known as chlorothene. The IUPAC name is trichloroethene. Industrial abbreviations include TCE, trichlor, Trike, Tricky and tri. It has been sold | 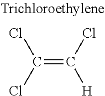 | Trichloroethylene | 201- 167-4 | 79-01-6 |
| | under a variety of trade names. Under the trade names Trimar | | | | |
| | and Trilene, trichloroethylene was used as a volatile | | | | |
| | anesthetic and as an inhaled obstetrical analgesic in millions of | | | | |
| | patients. | | | | |

TABLE 1F
Functional groups of organic compounds

| Or - | | | | | | | | | | |
|---|---|---|---|---|---|---|---|---|---|---|
| ganic | | | | | | | | | | |
| Com- | | | | | | | | | | |
| pound | Description | Chemical Structure of Functional Group | | | | | | Example | EU | CAS |
| Al- kanes | An alkane, or paraffin (a historical name that also has other meanings), is a saturated hydrocarbon. Alkanes consist only of hydrogen and carbon atoms and all bonds are single bonds. Alkanes (technically, always | Al- kane* | Al- kyl | RH | 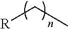 | alkyl- | 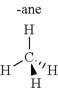 | Alkanes, C10-13, chloro (Short Chain Chlorinated Paraffins) | 287- 476- 5 | 85535- 84-8 |
| | acyclic or open-chain compounds) have the general chemical formula CnH₂n + 2. For example, methane is CH₄, in which n = 1 (n being the number of carbon atoms). Alkanes | Al- kene* | Al- kenyl | R₂C═CR₂ | 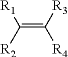 | alkenyl- | 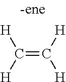 | | | |
| | belong to a homologous series of | Al- | Alky- | RC≡CR′ | R—═—R′ | alkynyl- | -yne | | | |
| | organic compounds in which the | kyne* | nyl | | | | H—C≡C—H | | | |
| | members differ by a molecular mass | | | | | | | | | |
| | of 14.03 u (mass of a methanediyl | | | | | | | | | |
| | group, —CH₂—, one carbon atom of | | | | | | | | | |
| | mass 12.01 u, and two hydrogen | | | | | | | | | |
| | atoms of mass ≈1.01 u each). There | | | | | | | | | |
| | are two main commercial sources: | | | | | | | | | |
| | petroleum (crude oil) and natural | | | | | | | | | |
| | gas. | | | | | | | | | |

| | | | | | |
|---|---|---|---|---|---|
| PAHs | Standard line angle schematic representation of an important PAH, benzo[a]pyrene, where carbon atoms are represented by the vertices of the hexagons, and hydrogens are inferred as projecting out at 120° angles to fill the fourth carbon valence | Anthracene; Tricyclo[8,4.0.0^{3,8}]-tetradeca- 1,3,5,7,9,11,13-heptaene 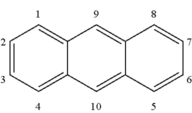 [SMILES: c1ccc2cc3ccccc3cc2c1] | Anthracene Functional Group | 204- 371- 1 | 120- 12-7 |

TABLE 1G
Functional groups of organic compounds

| Organic | | | | | | | | | | |
|---|---|---|---|---|---|---|---|---|---|---|
| Com- | | | | | | | | | | |
| pound | Description | Chemical Structure of Functional Group | | | | | | Example | EU | CAS |
| Amine | Amines are organic compounds and functional groups that contain a basic nitrogen atom with a lone pair. Amines are derivatives of ammonia, wherein one or more hydrogen atoms have been replaced by a | Amines | Primary amine | RNH₂ | 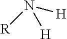 | amino- | 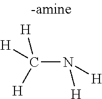 | 4-methyl-m- phenylene- diamine (toluene-2,4- diamine) | 202- 453-1 | 95-80-7 |
| | substituent such as an alkyl or | | | | | | | | | |
| | aryl group. (These may respectively be called alkylamines and arylamines; amines in which both types of | | Second- ary amine | R₂NH | 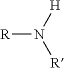 | amino- | -amine | | | |
| | substituent are attached to one | | | | | | | | | |
| | nitrogen atom may be called alkylarylamines.) Important amines include amino acids, biogenic amines, trimethylamine, and aniline; | | Tertiary amine | R₃N | 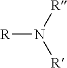 | amino- | 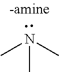 | | | |
| | see Category: Amines for a list | | | | | | | | | |
| | of amines. Inorganic derivatives of ammonia are also called amines, such as chloramine (NClH₂); see Category: Inorganic amines. | | 4° ammo- nium ion | R₄N⁺ | | ammonio- | 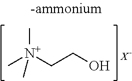 | | | |
| | Compounds with a nitrogen | | | | | | | | | |
| | atom attached to a carbonyl | | | | | | | | | |
| | group, thus having the | | | | | | | | | |
| | structure R—CO—NR′R″, are | | | | | | | | | |
| | called amides and have | | | | | | | | | |
| | different chemical properties | | | | | | | | | |
| | from amines. | | | | | | | | | |

TABLE 1H
Functional groups of organic compounds

| Organic | | | | | |
|---|---|---|---|---|---|
| Com- | | Chemical Structure of | | | |
| pound | Description | Functional Group | Example | EU | CAS |
| Anhy- dride | An acid anhydride is a compound that has two acyl groups bonded to the same oxygen atom. A common type of organic acid anhydride is a carboxylic anhydride, where the parent acid is a carboxylic acid, the formula of the | 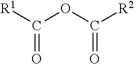 | Hexahydromethylphthalic anhydride [1], Hexahydro-4-methylphthalic anhydride [2], | 247- 094-1 | 25550- 51- 0″19438- 60- |
| | anhydride being (RC(O))2O. Symmetrical acid anhydrides of | | Hexahydro-1-methylphthalic | | 9″48122- |
| | this type are named by replacing the word acid in the name | | anhydride [3], | | 14- |
| | of the parent carboxylic acid by the word anhydride.[2] | | Hexahydro-3-methylphthalic | | 1″57110- |
| | Thus, (CH₃CO)₂O is called acetic anhydride. Mixed (or | | anhydride [4] | | 29-9 |
| | unsymmetrical) acid anhydrides, such as acetic formic | | [The individual isomers | | |
| | anhydride | | [2], [3] and [4] (including | | |
| | | | their cis- and trans- stereo | | |
| | | | isomeric forms) and all | | |
| | | | possible combinations | | |
| | | | of the isomers [1] | | |
| | | | are covered by this entry] | | |
| TGIC | TGIC, in its molten state reacts easily with various functional groups in the presence of catalysts or promoters. TGIC, like other similar epoxides, can react with amines, carboxylic acids, carboxylic acid anhydrides, phenols and alcohols. In the actual curing process, these reactions are more complex because of their side reactions. | 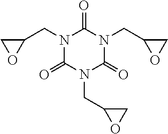 [SMILES: O=c1n(CC2CO2)c(=O)n(CC2CO2)c(=O)n1CC1CO1] | 1,3,5-Tris(oxiran-2- ylmethyl)-1,3,5- triazinane-2,4,6-trione (TGIC) | 219- 514-3 | 2451- 62-9 |
| Michler | Michler's ketone is an organic compound with the formula of [(CH₃)₂NC₆H₄]2CO. This electron rich derivative of benzophenone is an intermediate in the production of dyes and pigments, for example Methyl violet. It is also used as a photosensitizer. The ketone is prepared today as it was originally by Michler using the Friedel-Crafts acylation of dimethylaniline (C₆H₅NMe₂) using phosgene (COCl2) or equivalent reagents such as triphosgene (Me = methyl):[2] COCl₂ + 2 C₆H₅NMe₂ → (Me₂NC₆H₄)2CO + 2 HCl The related tetraethyl compound (Et₂NC₆H₄)2CO, also a precursor to dyes, is prepared similarly. | 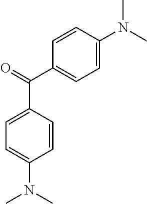 [SMILES: CN(C)c1ccc(C(=O)c2ccc(N(C)C)cc2)cc1] | 4,4′-bis(dimethylamino)-4″- (methylamino)trityl alcohol [with ≥0.1% of Michler's ketone (EC No. 202-027-5) or Michler's base (EC No. 202-959-2)] | 209- 218-2 | 561-41-1 |

What is claimed is:

1. A method of detecting presence and determining concentration of a target organic compound in a sample, the method comprising:
dissolving a target sample in an organic solvent to obtain a sample solution,
applying a probing device to the sample solution to form a target analyte, wherein the probing device is an SMIP probe comprising a solvatochromic molecularly imprinted polymer, and the SMIP probe comprises a solvatochromic functional group or a solvatochromic functional monomer the colour and/or fluorescence properties of which will change upon coupling or encountering the target organic compound or when the target organic compound is captured by the SMIP probe, and
detecting or determining presence and concentration of the target organic compound with reference to a responsive optical signal such as colorimetric, luminescent and/or fluorescent response of the target analyte.

2. The method according to claim 1, wherein the presence and concentration of the target organic compound is determined by applying an excitation optical signal to the target analyte and by measuring intensity of the responsive optical signal which is emitted by the target analyte in response, and the concentration of the target organic compound is determined according to detected solvatochromic properties exhibited by the target analyte when subject to an optical excitation signal.

3. The method according to claim 2, wherein the intensity of the responsive optical signal being measured is the intensity of a selected wavelength or intensities of selected wavelengths, and wherein the selected wavelength is different to the wavelength of the excitation optical signal and the selected wavelengths comprise wavelengths which are different to the wavelength of the excitation optical signal.

4. The method according to claim 1, wherein the target analyte is a composite analyte formed by the SMIP capturing the target organic compound, and the method comprises examining solvatochromic properties of the target analyte to determine qualitatively and quantitatively the target organic compound in the sample.

5. The method according to claim 1, wherein the target analyte is a composite analyte formed by the SMIP capturing the target organic compound, and wherein the composite analyte includes a unique solvatochromic property that intensity of a characteristic wavelength of the composite analyte is to change with a change in concentration of the target analyte; and wherein the method comprises utilizing the unique solvatochromic property to facilitate detecting presence and determining concentration of the target organic compound.

6. The method according to claim 5, wherein the presence and concentration of the target organic compound is determined by applying an excitation optical signal to the target analyte and by measuring intensity of the responsive optical signal which is emitted by the target analyte in response, and the concentration of the target organic compound is determined according to detected solvatochromic properties exhibited by the target analyte when subject to an optical excitation signal; and wherein the responsive optical signal has a peak light emission frequency and the characteristic wavelength is the peak light emission frequency; and wherein the intensity of the peak light emission frequency is measured to facilitate detecting presence and determining concentration of the target organic compound.

7. The method according to claim 1, wherein the target analyte is a composite analyte formed by the SMIP capturing the target organic compound, and wherein the composite analyte has a unique solvatochromic property that the responsive optical signal has a wavelength distribution which is to change with a change in concentration of the target analyte; and wherein the method comprises utilizing the unique solvatochromic property to facilitate detecting presence and determining concentration of the target organic compound.

8. The method according to claim 7, wherein the optical excitation signal is in the ultra-violet region, and the responsive optical signal has a spectrum having a wavelength distribution between 425 nm and 745 nm and of different intensities when subject to excitation by an excitation optical signal having a wavelength in the ultra-violet region.

9. The method according to claim 8, wherein the presence and concentration of the target organic compound is determined by applying an excitation optical signal to the target analyte and by measuring intensity of the responsive optical signal which is emitted by the target analyte in response, and the concentration of the target organic compound is determined according to detected solvatochromic properties exhibited by the target analyte when subject to an optical excitation signal; and wherein the responsive optical signal comprises fluorescent light, and the fluorescent light has a peak frequency which changes as concentration of the target analyte changes; and wherein relationships or correlation between responsive optical signal intensity and concentration of the target composite analyte are utilised to facilitate detecting presence and determining concentration of the target organic compound.

10. The method according to claim 9, wherein the responsive optical signal intensity and the concentration of the target composite analyte are related by a linear equation or a linear calibration curve.

11. The method according to claim 1, wherein the method comprises a microprocessor-based circuitry evaluating qualitative and/or quantitative characteristics optical properties of the received optical response signal to determine and output qualitative and/or quantitative characteristics of the sample analyte or sample analytes carried on the sample carrier by execution of stored instructions and with reference to stored data and/or decision criteria.

12. The method according to claim 1, wherein the method comprises holding a predetermined quantity of an SMIP probe in a polar organic solvent on a probe location on a solid-state substrate such as a transparent plastic card or a cartridge, or a predetermined quantity of a plurality of SMIP probes on plurality of selected probe locations on the solid state substrate to form an SMIP detector to facilitate detecting presence and determining concentration of the target organic compound.

13. The method according to claim 12, wherein the target organic compound is a phthalate or a phthalate-based plasticizer, and/or comprises one or more than one of the functional groups of Tables 1A-1H, and/or having solvatochromic-concentration properties of FIGS. 4A to 4J; and/or wherein the target phthalate or the phthalate-based plasticizer is any one of the phthalates identified in Table 3.

14. A detection apparatus for detection of a target organic compound in a sample, wherein the apparatus comprises a sample receptacle for receiving a target analyte, an optical arrangement for emitting an excitation optical signal to the target analyte and for detecting a responsive optical signal which is emitted from the target analyte in response to the excitation optical signal, and a processor comprising microprocessor-based circuitry to determine qualitative and/or quantitative information of the target organic compound in the sample according to solvatochromic properties and/or with reference to colorimetric, luminescent and/or fluorescent response of the target analyte; wherein the target analyte comprises analyte composites and each analyte composite comprises a probing device and a target organic compound or at least a characteristic functional group thereof; wherein the probing device comprises a solvatochromic molecularly imprinted polymer which forms an SMIP probe, and the SMIP probe comprises a solvatochromic functional group or a solvatochromic functional monomer the colour and/or fluorescence properties of which is to change upon encountering or coupling with the target organic compound.

15. The detection apparatus according to claim 14, wherein the processor is to determine concentration of the target organic compound with reference to intensity of the responsive optical signal at a selected wavelength or selected wavelengths, the selected wavelength being different to the wavelength of the excitation optical signal and the selected wavelengths comprises wavelengths which are different to the wavelength of the excitation optical signal, and wherein the optical arrangement comprises an optical compartment and the sample receptacle is inside the optical arrangement.

16. The detection apparatus according to claim 15, wherein the optical arrangement comprises an optical source which is to emit ultra-violet light as an excitation optical signal towards the sample receptacle during operations and an optical receiver to receive and detect optical response signals coming from the sample receptacle in response to the excitation optical signal; and wherein the optical response signals has a spectrum having a wavelength distribution between 425 nm and 745 nm.

17. The detection apparatus according to claim 14, wherein the responsive optical signal has a peak frequency which changes as concentration of the target analyte changes; and wherein the apparatus comprises a microprocessor-based circuitry for evaluating qualitative and/or quantitative characteristics optical properties of the received optical response signal to determine and output qualitative and/or quantitative characteristics of the sample analyte or sample analytes carried on the sample carrier by execution of stored instructions and with reference to stored data and/or decision criteria.

18. The detection apparatus according to claim 17, wherein the target organic compound is a phthalate or a phthalate-based plasticizer, and/or comprises one or more than one of the functional groups of Tables 1A-1H, and/or having solvatochromic-concentration properties of FIGS. 4A to 4J; and/or wherein the target phthalate or the phthalate-based plasticizer is any one of the phthalates identified in Table 3; and wherein the microprocessor-based circuitry is to determine concentration of the target analyte with reference to a set of calibration data or with reference to a linear equation obtained form the set of calibration data.

19. An organic compound detector comprising an SMIP probe for quantitative detection of a target organic compound in a sample, wherein the SMIP probe comprises a solvatochromic molecularly imprinted polymer having a solvatochromic functional group or a solvatochromic functional monomer and a receptor site for selective capture or selective attachment of the target organic compound, wherein the SMIP probe is to change its colour and/or fluorescence properties upon coupling, capturing or encountering the target organic compound; and wherein the SMIP probe is deposited or held on a transparent or translucent solid-state substrate.

20. The detector according to claim 19, wherein the solid-state substrate in the form of a card or a cartridge, and wherein a plurality of SMIP probes for detecting a corresponding plurality of target organic compounds are held on the solid-state substrate; and wherein the SMIP probe after capture a corresponding target organic compound is to emit a fluorescent light of a second frequency when excited by a source light of a first frequency different to the second frequency; and wherein intensity of the fluorescent light correlates to concentration of the target organic compound.
